(19) United States
(12) Patent Application Publication
(10) Pub. No.: US 2005/0216477 A1
(43) Pub. Date: Sep. 29, 2005

(54) Computer network management apparatus and method

(75) Inventor: Shinji Nakadai, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/083,244

(22) Filed: Mar. 18, 2005

(30) Foreign Application Priority Data
Mar. 23, 2004 (JP) 2004-084395

(51) Int. Cl. G06F 17/30

(52) U.S. Cl. 707/10

(57) ABSTRACT

A network management system includes a schema storage storing a system schema which describes a conceptual structure of a computer network to be managed. Based on input information of two system elements and the system schema, an information acquisition procedure is generated and is used to acquire information of system element and association linking the two system elements from the managed computer network.

### BACKGROUND OF THE INVENTION

1. Field of the Invention

The present invention relates to a computer network management technique and in particular to a computer network management system and method which can generate an information acquisition procedure required to acquire information about a dependency relationship between two system elements included in a managed computer network system.

2. Description of the Related Art

Computer network systems today are pursuing the path of diversity. For example, some computer network system is composed of various and disparate system elements, for example, link layer protocols such as Ethernet, MPLS (Multiprotocol Label Switching) and ATM (Asynchronous Transfer Mode), computer OSs (Operating Systems) such as Windows™ and Linux™, and so on. Having dependency relationships with one another, these system elements constitute a computer network system.

For the sake of clarity, several terms used in the disclosure will be explained.

System Element

The term “system element” includes not only hardware and software but also information about a security policy and the like and humans (e.g., a system administrator, a user and the like). Examples of hardware are computer, switch, network interface card, and the like. Examples of software are OSs and the like. Those mentioned here are cited as examples, and hardware and software are not limited to the foregoing.

Dependency relationship

The term “dependency relationship” between system elements means such a relationship that the system elements are linked together in a chain directly or with other system element(s) in between.

Linkage

The meaning of the term “linkage” includes the followings: being physically connected, being installed, a person using hardware or software, a person belonging to an organization, hardware or software being assigned to an organization, and so on. Such links may be concatenated to form a “dependency relationship” between system elements.

Resolving a Dependency Relationship

Clarifying a dependency relationship between two system elements will be referred to as “resolving a dependency relationship.”

An example of a dependency relationship between system elements will be given below. It is assumed that a DHCP (Dynamic Host Configuration Protocol) server in some computer network system has the name “A.” This server A has a network interface card eth0 incorporated therein, and this network interface card eth0 implements Ethernet protocol. Moreover, the network interface card eth0 uses the Ethernet protocol to be connected to the port 1 of a switch B at Layer 2. This is an example of a dependency relationship between the server A (DHCP server) and the switch B, viewed from a network aspect. In addition, from a different aspect other than the network aspect, the DHCP server may have a dependency relationship with another system element. For example, the DHCP server also has a dependency relationship with some kind of software, and with a server administrator.

When resolving a dependency relationship, two system elements are input information, and a dependency relationship between the two system elements are output information. These input information and output information are in a correspondence with each other. Therefore, resolution of a dependency relationship will sometimes be referred to as “establishing a correspondence” between two system elements (input information) and a dependency relationship (output information) between the two system elements. For example, resolution of a dependency relationship between the switch B and the server is to establish a correspondence between “the switch B and the server” and “a dependency relationship of switch B, port 1, layer-2 connection, network interface card eth0, and server A.”

As described above, a computer network system today includes many different system elements having dependency relationships with one another, which may form a computer network system. Accordingly, we can say as follows:
Construction of computer network system is to provide dependency relationships to a plurality of system elements;
Operation of computer network system is to maintain predetermined dependency relationships; and
Change of system configuration is to change dependency relationships.

Therefore, to construct or operate such a computer network system or to change its configuration, a system administrator needs to grasp information about what dependency relationship a system element of interest has with another system element.

Using the aforementioned example with the DHCP server, we will explain the necessity of grasping dependency relationships when operating a system or changing a system configuration. It is assumed that a system administrator now wants to power off the switch B to change the system configuration. At this time, if the system administrator powered off the switch B without grasping a dependency relationship of this switch B with another system element, the connectivity between the DHCP server and the switch B could be lost, and along with this, the connectivity between the DHCP server and another server could be lost. For the DHCP function to continue running in the computer network system, this DHCP server needs to secure the connectivity with another server even if the switch B is powered off. To achieve this, the DHCP server needs to be provided with another network interface card by which the DHCP server is bought in a state capable of connecting to another switch. Accordingly, in order to determine whether or not the switch B can be powered off, it is needed to grasp a dependency relationship between the switch B and the DHCP server, and a dependency relationship between the DHCP server and another server.

As described above, for a system administrator to properly construct or operate a computer network system or to change its configuration, it is important to grasp information about a system element that is in a dependency relationship with a system element of interest.

A function of resolving (clarifying) a dependency relationship as describe above is needed not only for a single managed domain but also for integrally managing a diversified, large computer network by using a plurality of management applications. Further, in the case of managing a large computer network system by using a plurality of management applications, it is also required to provide commonality of information models to represent system elements among the management applications. Assume that two management applications employ different information models such that one management application manages a server as “Server,” but another management application manages a server as “Host.” In this case, it is difficult for the two management applications to manage a system in cooperation with each other. For cooperation on a management system, it is desirable that information models to be used by management applications should be shared among the management applications.

Therefore, DMTF (Distributed Management Task Force), which is the industry organization concerning computer network management, prescribes CIM (Common Information Model) as an information model common to computer network systems. Hereinafter, a modeling method according to this CIM will be described briefly. In the CIM modeling method, a computer network system is modeled mainly with classes and association classes. A class mostly represents a system element such as a server or a switch. An association class represents a relationship such as “an OS operates on a server.” For example, a server is modeled as a “ComputerSystem” class. Moreover, a relationship between an OS and a server, “an OS operates on a server,” is represented by an information model, “a ‘RunningOS’ association class refers to an ‘OperatingSystem’ class and a ‘ComputerSystem’ class.” A computer network system configuration described with such information models will be referred to as a system schema.

Further, in the modeling method according to CIM, the fact that a system element exists as an entity in a managed system will be represented as “an instance of a modeled class exists.” Specifically, the fact that a server A exists in a managed system is represented as “an instance ‘ComputerSystem.name=server A’ exists in a managed system.”

Furthermore, DMTF also prescribes a specification to allow an access to a system element in a managed system, such as a server or router, based on the above-described information model, CIM. This is a specification by the name of WBEM (Web Based Enterprise Management). For example, if a instruction to acquire an instance of “ComputerSystem” is executed in accordance with WBEM, an instance “ComputerSystem.name=server A” is obtained. In addition, there is also a instruction for acquiring an instance of an associated class by designating an instance, an association class referring to this instance, and the associated class. This instruction is called an “Associator” instruction. For example, when a instruction to acquire an “OperatingSystem” class that is associated with an instance “ComputerSystem.name=server A” through a “RunningOS” association class is executed in accordance with WBEM, an instance of “OperatingSystem” can be acquired.

A conventional method for resolving a dependency relationship in a computer network management system is described in, for example, Japanese Patent Application Unexamined Publication No. 2000-341270. The configuration of a network management processing device described in this publication is shown in FIG. 1. The network management processing device includes a main processing section 110 for carrying out main processing concerning network management, a topology management module section 140 for storing topology information on a network, a scenario storage section 130 for storing scenario data indicating a procedure of acquiring information from the topology management module section 140, a file reading section 121 for reading the scenario, a scenario storage table 122 for storing the scenario as a result of the reading, and a retrieval execution section 123 for executing retrieval based on the scenario. The scenario here indicates a series of information acquisition procedure steps of: for example, acquiring information about a port on a switch from the switch; acquiring information about a network interface connected to the switch; and acquiring information about a server having the network interface card.

The conventional network management processing device having such a configuration operates as follows. Specifically, the main processing section 110 in which a management application is installed requests to acquire network topology information in a dependency relationship with a managed system element. The file reading section 121 reads a scenario matching the request from the scenario storage section 130 and stores the scenario in the scenario storage table 122. As a result, stored is the scenario in which, for example, as mentioned above, information about a port on a switch is acquired from the switch and information about a network interface connected to the switch is acquired. Next, the main processing section 110 designates an object that is the source of resolving the dependency relationship, calls the retrieval execution section 123 and allows it to perform retrieval on the topology management module section 140, based on the scenario stored in the scenario storage table 122. The main processing section 110 then notifies all the retrieval results to the management application. For example, it is assumed that an object by the name of “switch B” is designated and that the above-mentioned information acquisition procedure from the switch up to the server is extracted. If retrieval is performed in accordance with this procedure, the following results. Specifically, from the switch B, information about a port belonging to the switch is acquired, and from this result, information about a network interface card possessed by a server, and then information about the server, are acquired. The results obtained here are information indicating, for example, that the switch B is connected via the port 1 to the server having the network interface card eth0. That is, it is possible to obtain, as an output, only the entity information on system elements, such as a server and a network interface card, constituting a scenario that is given beforehand.

With such an operation, the function of resolving a dependency relationship between system elements by executing an information acquisition procedure can be separated from a management application. As a result, it is possible to omit labor involved in rewriting a main management application program when changing a system configuration of a managed system, or the like.

However, the above-mentioned network management processing device has the following disadvantages. First, a system administrator or management application developer needs to generate a scenario indicating an information acquisition procedure. Otherwise, pieces of information concerning a managed system cannot be associated with each other. In other words, if a system administrator or the like gives no scenario to the network management processing device, a dependency relationship between system elements of a managed system cannot be resolved.

Second, in the case of the conventional device as described above, the types of resolvable information association are fixed. That is, the types of association between system elements that are input information and a dependency relationship that is output information, are fixed. In other words, a scenario that is stored beforehand can resolve only a dependency relationship between some predetermined system elements. In addition, the types of system information obtained as a dependency relationship are limited to those according to a scenario stored beforehand.

Third, when a new system element is added to a managed system, the burden on a system administrator becomes heavier. That is, when a new system element is added to a managed system, a system administrator has to generate such a scenario as to acquire entity information on the new system element. A scenario can be said to be a kind of program, and therefore the burden of scenario creation becomes heavier.

### SUMMARY OF THE INVENTION

Accordingly, an object of the present invention is to provide computer network management apparatus and method, which make it possible to resolve or clarify a dependency relationship between system elements without the need of creating an information acquisition procedure by a system administrator.

Another object of the present invention is to provide computer network management apparatus and method, which can place no restriction on system elements between which a dependency relationship can be resolved.

Still another object of the present invention is to provide computer network management apparatus and method, which can reduce the burden on a system administrator when a new system element is added to a managed system.

According to the present invention, a system schema memory stores a system schema which describes a configuration of a managed network system by modeling the system elements and associations between the system elements in predetermined representation form. An information acquisition procedure generator generates an information acquisition procedure based on input information of two system elements and the system schema, wherein the information acquisition procedure is used to acquire information of system element and association linking the two system elements from the managed network system.

The information acquisition procedure generator may include a searcher or a searching function, which searches the system schema memory for modeled information of system element and association linking the two system elements by sequentially finding modeled information of a system element associated with a single system element and modeled information of an association between the single system element and the associated system element from one of the two system elements to the other of two system elements.

The system schema stored in the system schema memory may include a multiplicity which indicates a number of entities of a system element associated with a single system element when said single system element is associated with one of the single system element itself and another system element. The search may be prohibited from performing such a returning operation as to search for the single system element from the associated system element and thereafter again search for the associated system element a number of times equal to or greater than the number of entities indicated by the multiplicity.

The apparatus may further include an element designating section for designating a system element to be included in the information acquisition procedure or a system element to be excluded from the information acquisition procedure. When a system element is designated as one to be included, the information acquisition procedure generator generates the information acquisition procedure including modeled information of the system element that is designated as one to be included, and when a system element is designated as one to be excluded, the information acquisition procedure generator generates the information acquisition procedure excluding modeled information of the system element that is designated as one to be excluded.

The apparatus may further include an association designating section for designating an association to be included in the information acquisition procedure or an association to be excluded from the information acquisition procedure. When an association is designated as one to be included, the information acquisition procedure generator generates the information acquisition procedure including modeled information of the association that is designated as one to be included, and when an association is designated as one to be excluded, the information acquisition procedure generator generates the information acquisition procedure excluding modeled information of the association that is designated as one to be excluded.

The apparatus may further include an information acquisition section for acquiring information of system element and association linking the two system elements from the managed network system according to the information acquisition procedure generated by the information acquisition procedure generator. In this case, the apparatus may further include: an output section for outputting information acquired by the information acquisition section; and a condition designating section for designating a condition under which the information to be outputted is determined. The information acquisition section may acquire information satisfying the condition designated from the managed network system. The output section may output information satisfying the condition designated of information acquired by the managed network system.

The system schema memory may store a plurality of system schemas. The apparatus may further include a system schema selector for selecting one of the plurality of system schemas depending on a system schema selection instruction received from outside, wherein the information acquisition procedure generator generates an information acquisition procedure based on a system schema selected by the system schema selector. The system schema selector may select one of the plurality of system schemas depending on the input information of the two system elements.

The system schema stored in the system schema memory may include modeled information of system elements having an inheritance relationship. When searching for modeled information of a system element associated with a system element inheriting from another system element, the searcher may also search for modeled information of a system element associated with the other system element and a system element inheriting from a system element associated with the other system element.

According to another aspect of the present invention, a method includes: storing a system schema in a system schema memory, wherein the system schema describes a configuration of a managed network system by modeling the system elements and associations between the system elements in predetermined representation form; inputting information of two system elements of the plurality of system elements; and generating an information acquisition procedure based on input information of the two system elements and the system schema, wherein the information acquisition procedure is used to acquire information of system element and association linking the two system elements from the managed network system.

According to still another aspect of the present invention, a computer-readable program instructing a computer to manage a network system including a plurality of system elements, wherein the computer comprises a system schema memory storing a system schema which describes a configuration of a managed network system by modeling the system elements and associations between the system elements in predetermined representation form, the program comprising the step of generating an information acquisition procedure based on input information of two system elements and the system schema, wherein the information acquisition procedure is used to acquire information of system element and association linking the two system elements from the managed network system.

As described above, according to the present invention, when inputting information of two elements among elements included in a managed computer network system, an information acquisition procedure is generated to acquire, from the managed computer network system, information indicative of elements linking the two elements and of associations between the elements, based on the inputted information of the two elements and the system schema. Therefore, even if a system administrator does not generate the information acquisition procedure, a dependency relationship between elements can be resolved. In addition, no restriction is imposed on elements between which a dependency relationship can be resolved. Further, when a new element is added to the managed computer network system, the system administrator does not need to generate a new information acquisition procedure. Changing the system schema will suffice. Therefore, the burden on the system administrator can be dramatically reduced.

### BRIEF DESCRIPTION OF THE DRAWINGS

FIG. 1 is an explanatory diagram showing a configuration of a network management processing device;

FIG. 2 is an explanatory diagram showing an example of a system schema;

FIG. 3 is an explanatory diagram showing an example of a managed system;

FIG. 4 is an explanatory diagram showing an example of a path from a starting-point element to an end-point element;

FIGS. 5A and 5B are explanatory diagrams showing an example of an information acquisition procedure and an example of information acquired in accordance with the information acquisition procedure, respectively;

FIGS. 6A and 6B are explanatory diagrams showing relationships between a class, an instance and entity information;

FIG. 7 is a block diagram showing an example of a configuration of a computer network management system according to the present invention;

FIG. 8 is an explanatory diagram showing an example of a system schema;

FIG. 9 is a flowchart showing operations from when an information association request is inputted from an input device until requested information is outputted to an output device;

FIGS. 10A and 10B are explanatory diagrams showing that in some cases there are a plurality of aspects to a dependency relationship between system elements;

FIG. 11 is a flowchart of information acquisition procedure creation processing;

FIG. 12 is a diagram showing an example of a system schema;

FIG. 13 is an explanatory diagram showing a specific example of multiplicity;

FIG. 14 is an explanatory diagram showing examples of information acquisition procedures;

FIG. 15 is an explanatory diagram showing examples of information acquisition procedures;

FIG. 16 is an explanatory diagram showing examples of structures of information acquisition procedure data;

FIG. 17 is an explanatory diagram showing an example of a structure of information acquisition procedure data;

FIG. 18 is an explanatory diagram showing an example of a structure of information acquisition procedure data;

FIG. 19 is a flowchart of the processing of retrieving a relationship built between elements;

FIG. 20 is a flowchart of information acquisition processing according to an information acquisition procedure;

FIG. 21 is a flowchart of information acquisition procedure execution processing;

FIG. 22 is a flowchart of information acquisition processing;

FIG. 23 is an explanatory diagram showing an example of a system schema to be added;

FIG. 24 is an explanatory diagram showing an example of a system schema including elements that have an inheritance relationship;

FIG. 25 is a flowchart of the processing of searching for an element to which a retrieval pointer can be advanced from an element on which the retrieval pointer is currently set;

FIG. 26 is an explanatory diagram showing an example of a configuration of a managed system;

FIG. 27 is a diagram in which a plurality of information acquisition procedures generated are collectively expressed;

FIG. 28 is a diagram in which one information acquisition procedure is extracted from the plurality of information acquisition procedures;

FIG. 29 is a diagram expressing system information concerning a switch in accordance with a system schema;

FIG. 30 is a diagram showing a closed circuit formed by connecting a server and a firewall;

FIG. 31 is an explanatory diagram showing information acquired in accordance with an information acquisition procedure; and

FIG. 32 is an explanatory diagram showing an example of a system schema including elements that have an inheritance relationship.

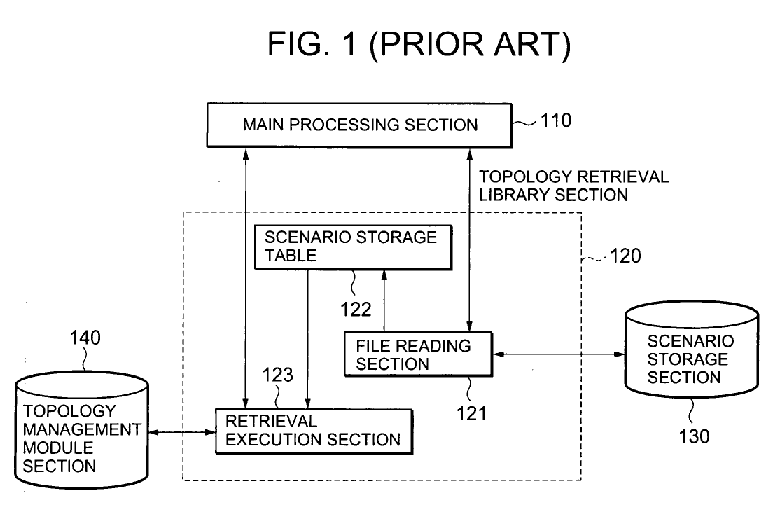

### DETAILED DESCRIPTION OF THE PREFERRED EMBODIMENTS

Hereinafter, preferred embodiments of the present invention will be described with reference to the accompanying drawings.

A computer network management system according to the present invention is a system that resolves a dependency relationship (hereinafter, merely referred to as a dependency) between system elements included in a computer network. As described already, resolving a dependency means here clarifying a dependency between two system elements.

General Outline

First, a description will be given of general operation of the computer network management system according to the present invention. The computer network management system stores in a memory a system schema representing a conceptual structure of a computer network. Conceptual structure of a computer network here includes a system configuration, for example, such that “an operating system (OS) is installed in a server,” “a network interface card is incorporated in a server,” or “a network interface card functions as an Ethernet port.” Each system schema representing such a configuration is composed of elements “server” and “OS,” and an association representing a relationship “the OS is installed in the server,” or the like.

Note that a system schema contains system elements included in a managed system and associations between the system elements. However, the system schema does not exhibit a one-to-one correspondence to a topology of the managed system. For example, when ten servers are present in the managed system, the system schema does not contain ten system elements each representing the servers. A system schema is dependent on the types of system elements included in a managed system, but independent of specific entity information such as the number of devices (e.g., servers), the names of the servers, and what OS and application are installed in the servers. Accordingly, a system schema contains classes (which will be described later) but not entity information (e.g., a server name and the like) on individual system elements.

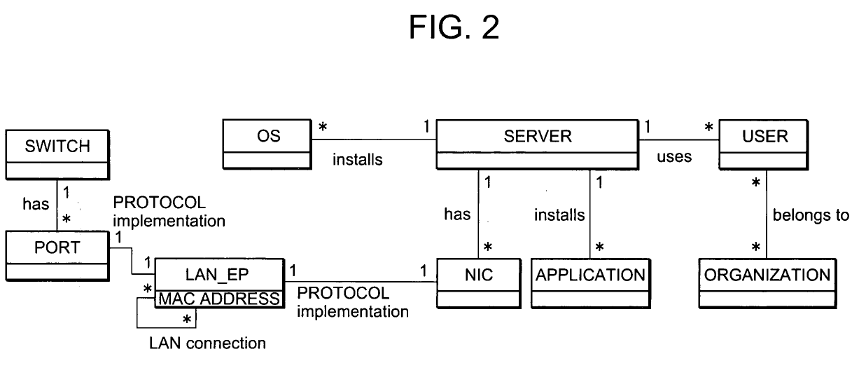

As shown in FIG. 2, an example of a system schema contains as system elements a server, an OS, an application, a network interface card (NIC), a switch, and the like. The system schema can be applied to any managed system that does not include any other elements than the system elements shown in FIG. 2. A topology for the managed system is not particularly limited. That is, the system schema can be applied to any managed system independently of the number of servers, the names of OSs and applications and the like only if the managed system does not include any other elements than the system elements shown in FIG. 2. In addition, if a managed system includes a system element that is not contained in the system schema shown in FIG. 2, such as a firewall, a system schema may be applied which contains a firewall as a system element and an association between the firewall and another system element.

Now, it is assumed that the computer network management system receives a request to grasp a dependency between two pieces of system information through an input device. The “system information” may be information on a class (which will be described later) of a system element that can be present in a computer network system, such as “server” or “Ethernet port,” or may be entity information indicating the fact that a system element is present in the computer network system, such as “a server by the name of A.” When the system information received from the input device is system entity information such as “a server by the name of A,” a class of the system element is specified based on the system entity information. For example, when entity information “server A” is inputted, the class of the system element, “server,” is specified based on this information.

Next, the computer network management system associates the respective classes of the system elements with elements in the system schema and then retrieves a relationship established between the corresponding two elements. That is, the computer network management system sets one of the elements as a starting-point element and the other as an end-point element, enumerates elements associated with the starting-point element, and then repeatedly further enumerates elements associated with an enumerated element, thus performing retrieval to find the end-point element.

For example, it is assumed that the storage section stores a system schema representing the following configuration: “A network interface card is incorporated in a server, and an OS is installed in the server. This network interface card is connected to a port of a switch.” When a request to grasp a dependency between a server by the name of A and an Ethernet port is received, the retrieval is started from an element representing the server, and an element representing the OS and an element representing the network interface card are enumerated. From the element representing the network interface card among those enumerated, an element representing the Ethernet port is enumerated. When the Ethernet port has been retrieved, a series of the retrieval results from the element representing the server to the element representing the Ethernet port is converted into an information acquisition procedure. More specifically, the elements that are the starting point of the retrieval and the next element, and an association connecting these elements are made the first information acquisition process, and similarly, the series of the retrieval results is respectively converted into information acquisition processes. The last information acquisition processing of the information acquisition procedure thus generated is the processing of acquiring the end-point element. Note that, when the elements are enumerated along these associations, it is determined whether or not an element can be enumerated, based on an attribute of the association, such as multiplicity. The multiplicity will be described later.

Next, to acquire information about a dependency that is actually present in the managed system, the entity information on the system elements received from the input device is inputted to the first information acquisition process of the generated information acquisition procedure, and then the first information acquisition process is executed. A result obtained from this first process is inputted into the next information acquisition process, and thereafter, a newly obtained result is inputted into the next process sequentially along the information acquisition procedure. Then, when information can be acquired from the system upon the execution of the last information acquisition process, a series of these acquisition results is sent to an output device. This series of the acquisition results indicates the dependency between the two pieces of system information received from the input device.

The general operation of the computer network management system according to the present invention will be described more specifically with reference to the drawings.

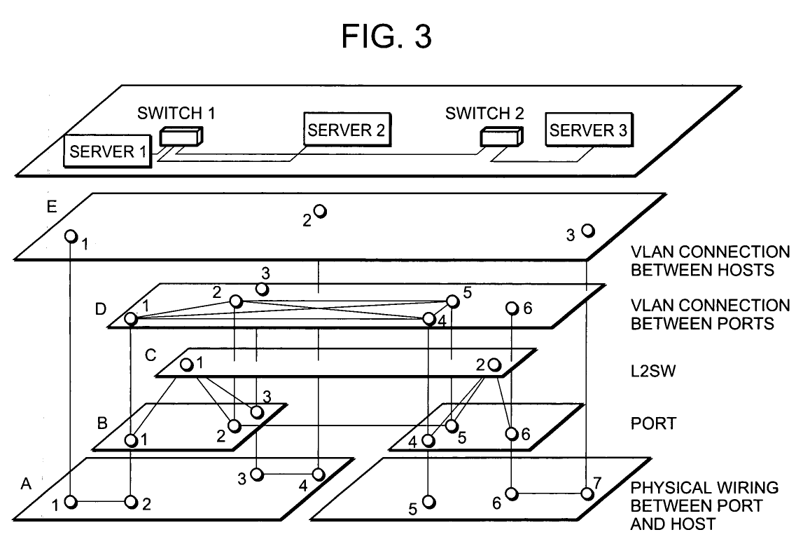

An example of a managed system as shown in FIG. 3 includes three servers and two switches. Moreover, each switch includes three ports. A layer A shown in FIG. 3 indicates physical wiring between the ports and the hosts in the managed system. For example, it is shown that the server 1 and a port of the switch 1 are physically connected to each other. A layer B indicates the ports of each switch. In the example shown in FIG. 3, it is shown that each switch has three ports. A layer C indicates the two switches. A layer D indicates VLAN (Virtual LAN) connections between the ports of the switches. A layer E indicates VLAN connections of the hosts.

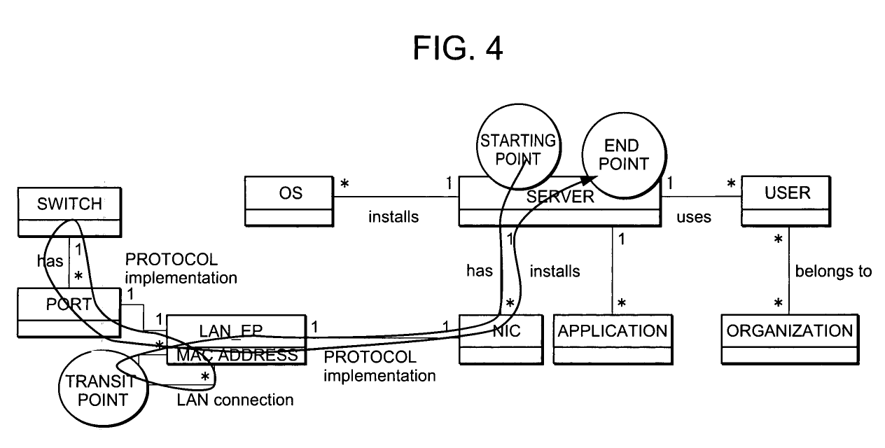

Here, it is assumed that a system administrator intends to grasp a dependency between the servers 1 and 2. In this case, information on the servers 1 and 2 are inputted in the computer network management system. The managed system shown in FIG. 3 does not include any other elements than the system elements shown in FIG. 2. Therefore, applying the system schema shown in FIG. 2, the respective two servers inputted are made to correspond to elements in the system schema. Then, one of the elements is set as a starting-point element, and the other is set as an end-point element. In this example, since both the pieces of information inputted indicate servers, the element “server” in the system schema is set as the starting-point element and also as the end-point element (see FIG. 3). The computer network management system enumerates elements associated with the starting-point element and repeatedly further enumerates elements associated with each enumerated element, thus performing retrieval to find the end-point element. The curved arrow in FIG. 4 represents a path of this retrieval.

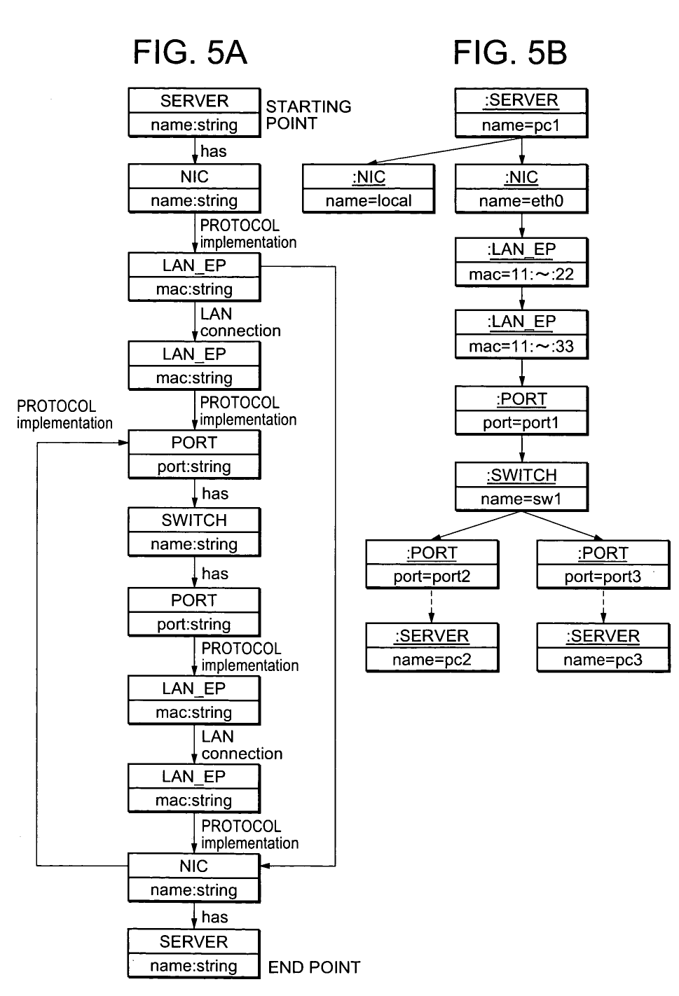

FIG. 5A shows an information acquisition procedure generated based on this retrieval path. Although the information acquisition procedure generated based on the retrieval path includes more steps than shown in FIG. 5A, for simplicity, the partly omitted information acquisition procedure is shown in FIG. 5A. The information acquisition procedure shown in FIG. 5A indicates that, from the server as a starting point, entity information on a network interface card (NIC) provided to the server (e.g., the identifier of NIC) is acquired, and thereafter, similarly, entity information on a LAN endpoint (e.g., MAC address) is acquired, and so on.

FIG. 5B shows the information acquired in accordance with this information acquisition procedure. Specifically, it is shown that an identifier “eth0” is acquired as the information on the network interface card included in the server (whose identifier is assumed to be “pc1.”) Thereafter, the information is sequentially acquired, and lastly the entity information “pc2” on the server 2 (whose identifier is assumed to be “pc2”) is acquired. A series of the acquired information from “pc1” to “pc2” represents a dependency between “pc1” and “pc2.” Note that there is a possibility that, as shown in FIG. 5B, information on a plurality of ports can be acquired from a switch with an identifier “sw1,” causing branches of information acquisition path. Accordingly, it is not always the case that only one dependency between “pc1” and “pc2” is specified.

The information representing the dependency thus acquired is used, for example, to confirm that “pc1” and “pc2” has a physical connection but not a VLAN connection. Moreover, the information representing the dependency may be used for a automatic VLAN connection setting device to automatically set a VLAN connection between “pc1” and “pc2.”

Next, a description will be given of the relationships between terms “class,” “instance” and “entity information,” used in the description below.

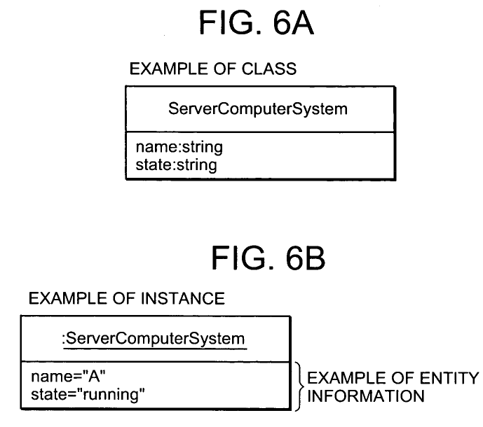

FIGS. 6A and 6B are explanatory diagrams showing the relationships between a class, an instance and entity information. A class represents a system element that does not include entity information such as an identifier. A “ServerComputerSystem” class as shown in FIG. 6A represents a server that is a system element. This, however, does not include entity information (specific contents of attributes) on the server. For example, the “ServerComputerSystem” class does not include attributes such as a given name and state information indicating whether or not the server is running. As an aside, “string” shown in FIGS. 5A and 6A indicates that a character string is to be given as an attribute. The classes shown in FIGS. 5A and 6A do not include a specific character string that is entity information. Here, although the class representing a server is taken as an example to discuss, the same applies to other classes. Additionally, the term “class” used in the present disclosure corresponds to a class in the object-oriented models such as UML (Unified Modeling Language) and CIM (Common Information Model). However, the term “class” will be used here also in an information model that is not object-oriented, as the meaning of a general system element including no entity information.

An “instance” is a class with the addition of entity information and corresponds to an object or instance in an object-oriented model. FIG. 6B shows an example of an instance. The instance shown in FIG. 6B includes such entity information that the name is “A” and the state is “running.” Note that, in the present disclosure, the term “instance” will be used even when modeling is performed using a non-object-oriented information model. Additionally, among names to be included in entity information, a name specified by a system administrator to be distinguished from other instances will be called “identifier.” As an aside, in FIG. 6B, “ServerComputerSystem” is represented by using a colon (:) and an underline (_) as symbols for indicating an instance.

Moreover, a term “association class” is used to represent the fact that there is a relationship between classes, and a term “association instance” is used to represent the fact that there is a relationship between instances. For example, an “association class” in CIM, including a reference to classes as an attribute, represents the fact that there is a relationship between the classes. Moreover, an “association instance” in CIM, including a reference to instances as an attribute, represents the fact that there is a relationship between the instances.

1. First Embodiment

A description will be given of the configuration of a computer network management system according to a first embodiment of the present invention.

1.1) System configuration

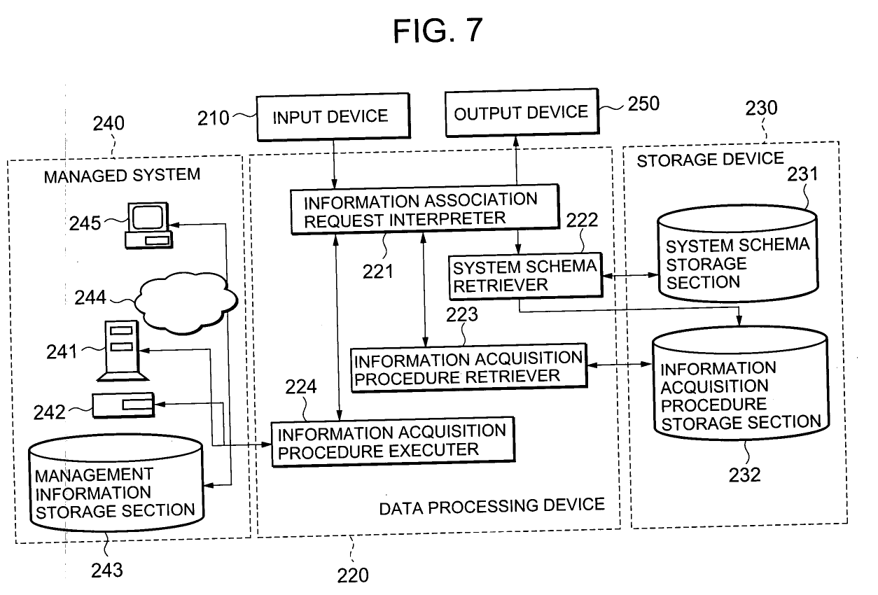

Referring to FIG. 7, the computer network management system includes a data processing device 220, a storage device 230, an input device 210, and an output device 250. The input device 210 and the output device 250 may be installed outside the computer network management system, as devices independent of the computer network management system. A managed system 240 is connected to the data processing device 220.

The input device 210 inputs a request to associate pieces of information (hereinafter, referred to as an information association request) into the data processing device 220, using protocol and data structure that enable information exchange with the data processing device 220. Specifically, the input device 210 inputs two pieces of system information and requests to output dependency information for these two pieces of system information. For example, the input device 210 may be a program-controlled computer that manages a computer network in cooperation with the system of the present invention. Alternatively, the input device 210 may be a program-controlled computer with a graphical user interface or instruction line interface that enables a system administrator to acquire information.

Moreover, an application for network management may be installed in the input device 210, and the input device 210 may input system information in accordance with this application. Alternatively, an application for managing users and organizations is installed in the input device 210, and the input device 210 may input system information in accordance with this application.

In response to the information association request inputted to the data processing device 220 by the input device 210, the output device 250 outputs the possibility or impossibility of the information association, or a result of the association performed (an association between the two pieces of system information and dependency information), which is a result of the processing carried out by the data processing device 220. For example, the output device 250 may be the same program-controlled computer as the input device 210. Alternatively, the output device 250 may by a program-controlled computer with a graphical user interface or instruction line interface that enables a system administrator to acquire information.

The managed system 240 includes, for example, a computer system including a computer 241, a router 242, a management information storage section 243, a computer 245 connected through a network 244, and the like. The managed system may be provided with a SNMP (Simple Network Management Protocol) agent that responds to a request for management information, a DMI (Desktop Management Interface) agent, an agent of its own that collects information from managed systems, WBEM (Web Based Enterprise Management) that collects management information as an agent, or the like. In addition, the managed system may be provided with a database for storing information set by a system administrator for the purpose of system management. Note that the types of devices to be included in the managed system 240 and connection relationships between the devices are not particularly limited.

Moreover, the managed system 240 provides entity information on the system elements included in the managed system 240, in response to a request received from the computer network management system (more specifically, the data processing device 220). For example, when the identifier and/or running state of the computer 241 are requested, the managed system 240 provides the identifier and the like in response to the request. Additionally, as mentioned before, a person can be a system element. Entity information on a person serving as a system element (e.g., person's name or the like) is stored in the management information storage section 243. That is, the entity information on a person is registered in the management information storage section 243 as data in a database. When the entity information on the person is requested, the management information storage section 243 provides the information in question to the computer network management system.

The storage device 230 includes a system schema storage section 231 and an information acquisition procedure storage section 232. The system schema storage section 231 stores a system schema representing the conceptual structure of the managed system 240. The system schema here is an information model representing the conceptual structure of a computer network, as described already. That is, the system schema here differs from a schema that is a data model representing a structure for storing data.

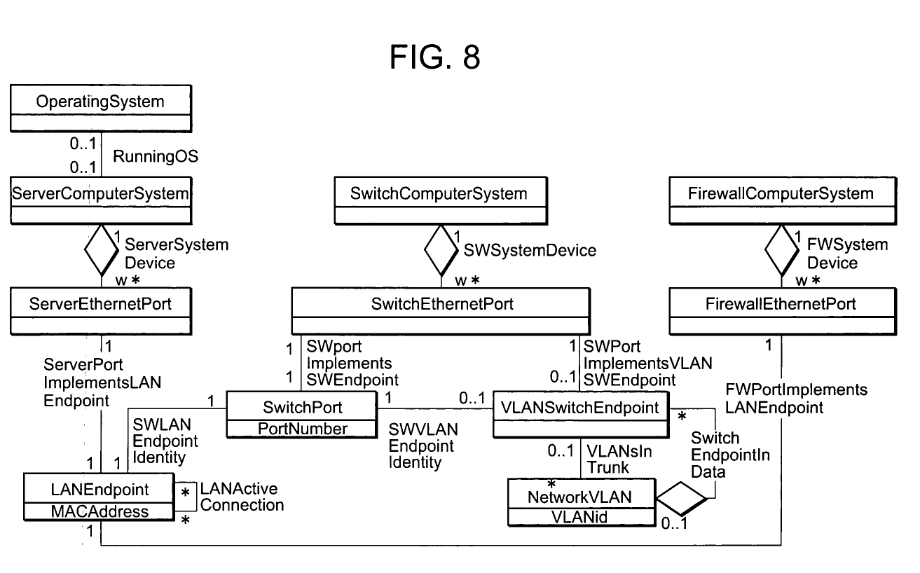

An example of the system schema is shown in FIG. 8. In FIG. 8, the system schema is represented using a UML (Unified Modeling Language) class diagram. In the system schema shown in FIG. 8, concepts of the system are described, such as “a server has zero or more Ethernet ports,” and “an Ethernet port of a switch may function as an endpoint of VLAN protocol.” Note that there may be a plurality of system schemas to be stored in the system schema storage section 231 so that one can be selected depending on the use of the system according to the present invention. Note that the numerals and symbols “1,” “0 . . . 1” and “*” shown in FIG. 8 indicate multiplicity, which will be described later.

The information acquisition procedure storage section 232 stores information acquisition procedures for the managed system 240. It is assumed that one information acquisition procedure is composed of a plurality of information acquisition processes. It is assumed here that the information acquisition procedure is composed of first to third information acquisition processes. First, the first information acquisition process is executed based upon entity information on the managed system, including an identifier and state information (indicating whether or not the device is running). Subsequently, based upon a result obtained by executing this first process, the second information acquisition process is executed. Further, based upon a result obtained by executing this second process, the third information acquisition process is executed. When the third information acquisition process has been executed, it is determined that the whole information acquisition procedure has been executed. In this way, using an information acquisition result obtained by executing an information acquisition process on a previous stage, the next information acquisition process is executed. Although this example shows a case where one information acquisition procedure includes three information acquisition processes, the number of information acquisition processes to be included in one information acquisition procedure is not limited to three.

A specific example of an information acquisition procedure will be given. Based upon a server name inputted from the input device 210, information about a network interface card in the server is acquired. Based upon the information about the network interface card, information about a port of a switch is acquired. Further, based upon the information about the port of the switch, a VLAN number is acquired. Such a series of steps is an information acquisition procedure. Incidentally, this information acquisition procedure is assumed to be an information acquisition procedure A.

The information acquisition procedure storage section 232 stores a plurality of information acquisition procedures as described above. Moreover, for example, identification information corresponding to the content of a request inputted from the input device 210 to the data processing device 220, is attached to each of the information acquisition procedures. In the case of the information acquisition procedure A in the above example, since this procedure is an information acquisition procedure for resolving a dependency between the server name and the VLAN number, the information acquisition procedure A is managed in association with the request to resolve this dependency between the server name and the VLAN number. For example, identification information indicating that the procedure is an information acquisition procedure for resolving a dependency between the server name and the VLAN number, is attached to the information acquisition procedure in question.

Note that a plurality of information acquisition procedures may exist for one request (a request to resolve a dependency) and the plurality of information acquisition procedures may be individually stored in the information acquisition procedure storage section 232. For example, when resolving a dependency between the server name and the VLAN number, an information acquisition procedure (which is assumed to be an information acquisition procedure B) as below can also be applied. Specifically, information about an owner of the server is acquired based on the server name; information about an organization to which the owner belongs is further acquired; information about the VLAN allocated to the organization is then acquired. Therefore, the information acquisition procedures A and B may be individually managed as information acquisition procedures for resolving a dependency between the server name and the VLAN number. That is, the identification information indicating that the procedure is an information acquisition procedure for resolving a dependency between the server name and the VLAN number may be attached to each of the information acquisition procedures A and B.

The data processing device 220 is an information processing device, for example, which reads programs and runs the programs thereon to perform the processing. The programs are stored on, for example, a ROM (not shown) provided to the computer network management system. The data processing device 220 includes an information association request interpreter 221, a system schema retriever 222, an information acquisition procedure retriever 223, and an information acquisition procedure executer 224. These individually operate as follows.

The information association request interpreter 221 interprets an information association request inputted from the input device 210 and determines whether or not retrieval to be performed on the system schema storage section 231 is needed. Moreover, the information association request interpreter 221 generates a retrieve instruction to be executed on the system schema storage section 231 and a retrieve instruction to be executed on the information acquisition procedure storage section 232. Furthermore, upon the reception of results of these retrievals, the information association request interpreter 221 generates an information acquisition procedure execute instruction for acquiring information on the managed system 240. Then, upon the reception of a result of the information acquisition operation for the managed system 240, the information association request interpreter 221 performs the filtering of the result, depending on a request from the input device 210. The information association request interpreter 221 sends the output device 250 the result subjected to the filtering, or the result not subjected to the filtering in the form as it is.

When an information acquisition procedure corresponding to an information association request inputted from the input device 210 has been already stored in the information acquisition procedure storage section 232, it is determined that retrieval to be performed on the system schema storage section 231 is not needed. On the other hand, when an information acquisition procedure corresponding to an information association request is not stored in the information acquisition procedure storage section 232, it is determined that retrieval to be performed on the system schema storage section 231 is needed. Through the retrieval performed on the system schema storage section 231, a new information acquisition procedure corresponding to the information association request is generated and stored in the information acquisition procedure storage section 232.

The system schema retriever 222 receives a system schema retrieve instruction generated by the information association request interpreter 221 and, based on this instruction, performs retrieval on the system schema storage section 231. Then, from a plurality of results obtained through this retrieval, the system schema retriever 222 generates an information acquisition procedure. Subsequently, the system schema retriever 222 stores this information acquisition procedure in the information acquisition procedure storage section 232 as an information acquisition procedure corresponding to an information association request received from the input device 210.

Preferably, a plurality of system schemas are stored in the system schema storage section 231, and the input device 210 designates a system schema to be used as a retrieval target by the system schema retriever 222. If a system schema is not designated, it is preferable that the information acquisition procedure interpreter 212 selects a default system schema, or selects a system schema depending on the type of an information association request. Alternatively, a system schema may be selected depending on the type of an application that causes the input device 210 to execute the processing of inputting system information. For example, when the input device 210 inputs system information in accordance with an application for network management, a system schema may be selected that includes more information on system elements to serve as nodes in the network and fewer system elements representing OSs and users. Alternatively, when the input device 210 inputs system information in accordance with an application for managing users and organizations, a system schema may be selected that includes less information on system elements to serve as nodes in the network and more system elements representing OSs and users.

If a system schema that represents the entire managed system including networks, users, computers, and so on, is designated as a retrieval target, the number of retrieval results and the number of steps in an information acquisition procedure generated based on the retrieval results become large. In contrast, if a retrieval target is, for example, a system schema that represents only a network according to the content of an information association request received from the input device 210, an information acquisition procedure concerning a user, which is originally unnecessary, does not need to be generated. Therefore, it is preferable to select a system schema depending on the type of an information association request, the type of an application that causes the input device 210 to execute the processing of inputting system information, and the like.

The information acquisition procedure retriever 223 receives a retrieve instruction to be executed on the information acquisition procedure storage section 232, generated by the information association request interpreter 221. Based upon the instruction, the information acquisition procedure retriever 223 retrieves an information acquisition procedure corresponding to the instruction from a plurality of information acquisition procedures stored in the information acquisition procedures storage section 232. The information acquisition procedure retriever 223 sends at least one information acquisition procedure obtained as a retrieval result to the information association request interpreter 221.

The information acquisition procedure executer 224 receives an information acquisition procedure execute instruction to be executed on the managed system 240, generated by the information association request interpreter 221, along with at least one information acquisition procedure. In accordance with this information acquisition procedure, the information acquisition procedure executer 224 executes the information acquisition process on the managed system 240. A result of the information acquisition procedure thus executed is sent to the information association request interpreter 221. In addition, the information acquisition procedure executer 224 converts an information acquisition process to be performed on the managed system 240 to determine an information acquisition method. For example, when an information acquisition process concerning a port of a switch is included in the information acquisition procedure, this information acquisition process is converted into such an information acquisition process as to acquire information of BRIDGE-MIB. dot1dPort of MIB (Management Information Base) by using SNMP. In another example, the information acquisition process is converted into such an information acquisition process as to execute Associator operation for WBEM, and so on.

Additionally, a database may be provided that stores entity information on each system element included in the managed system 240, and the information acquisition procedure executer 224 may acquire the information by accessing the database.

Preferably, the information acquisition procedure executer 224 sorts information acquisition procedures based on a rule such that an information acquisition procedure at a higher layer of network is executed on a priority basis. For example, if IP-layer connectivity exists between devices, then it is possible to consider that Layer-2 connectivity in some cases exists between the devices. In such a case, acquiring information about the Layer-2 connectivity can be omitted by first acquiring information about the IP-layer connectivity. Accordingly, if information acquisition procedures are sorted so that an information acquisition procedure belonging to a superior concept (a more comprehensive concept) is first executed and thus an information acquisition procedure belonging to an inferior concept (a less comprehensive concept) is omitted, then it is possible to obtain an effect of reducing the time required for acquiring a necessary retrieval result.

1.2) Operation

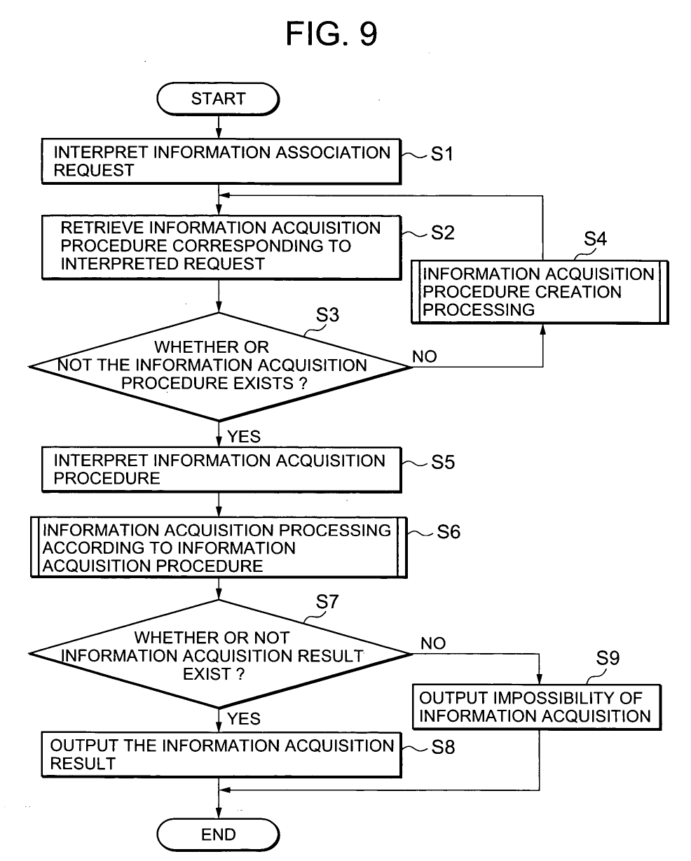

Next, an operation will be described with reference to a flowchart as shown in FIG. 9.

FIG. 9 shows an operation from when an information association request is inputted from the input device 210 until requested information is outputted to the output device 250. The information association request is inputted into the information association request interpreter 221 from the input device 210.

Format

Here, first of all, a description will be given of a format of an information association request to be received as an input, and a format of a result after an association has been made.

The format of information association request can be broadly classified into two types. A first request format is a format in which two instances (see FIG. 6B) are included as elements to be related, that is, as two pieces of information between which a dependency is to be resolved. The two instances may be given as one association instance. For example, an instance of a server with an identifier A and an instance of a firewall with an identifier B may be given, or an association instance indicating that a server with an identifier A uses a firewall with an identifier B may be given.

A second request format is a format in which one instance and one class (see FIG. 6A) are included as elements to be related, that is, as two pieces of information between which a dependency is to be resolved.

Note that there are also some cases where two classes are inputted as elements to be related, that is, as two pieces of information between which a dependency is to be resolved. In this case, the following conversion into the second request format may be performed: as for one of the two classes, querying the managed system 240 to acquire entity information (state information, identifier information, etc.) on system information corresponding to the class in question; and then performing a conversion so that this entity information is made an instance. If multiple pieces of information are acquired for the one of the classes, the second request format is to be made for each result. When a plurality of instances are obtained from the one of the classes, it suffices to resolve a dependency for each combination of the other class and individual instances obtained. Note that, as in the case of the first request format, two classes being designated are equivalent to one association class being designated. For example, a class representing a server and a class representing a firewall may be designated, or an association class indicating that a server uses a firewall may be designated.

In addition, as information given from the input device 210, apart from the information association request, there is information that is given as an option and does not necessarily have to be inputted. (Hereinafter, this information will be referred to as optional information.)

As first optional information, a class or an association class may be designated that indicates what manner of dependency exists between two system elements which is to be resolved.

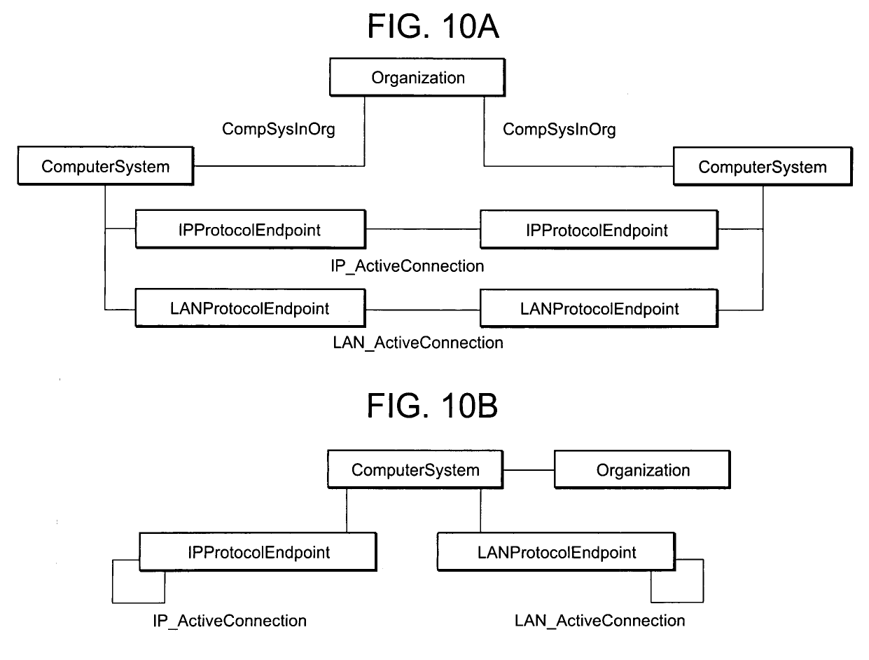

FIGS. 10A and 10B show that there is a case where a plurality of manners of dependency exists between system elements. In FIG. 10A, elements such as “ComputerSystem” are represented as instances. It is shown that two computer systems are managed in a single organization (“Organization”). It is shown that the two computer systems are connected in conformity with IP protocol and also connected in conformity with LAN protocol. In this case, the dependency between the two computer systems can be represented as a manner of “ComputerSystem, Organization, ComputerSystem.” It also can be represented as a manner of “ComputerSystem, IPProtocolEndpoint, IPProtocolEndpoint, ComputerSystem.” Similarly, it also can be represented as a manner of “ComputerSystem, LANProtocolEndpoint, LANProtocolEndpoint, ComputerSystem.” The first optional information designates a specific manner among such a plurality of manners. In FIG. 10B, the elements such as “ComputerSystem” are represented as classes. Unlike the case shown in FIG. 10A, each element such as “ComputerSystem” is represented by one class because the class is an abstracted model including no entity information.

The data processing device 220 resolves a dependency using a designated manner. For example, when an association class “IP_ActiveConnection” is designated as the first optional information, the data processing device 220 resolves a dependency between two computer systems in a manner of “ComputerSystem, IPProtocolEndpoint, IPProtocolEndpoint, ComputerSystem.”

In addition, a plurality of manners may be designated by one class or association class. For example, it is assumed that both an association class “IP_ActiveConnection” and an association class “LAN_ActiveConnection” are subclasses of an association class “ActiveConnection.” In this case, if “ActiveConnection” is designated as the first optional information, a dependency between two computer systems may be resolved in manners specified by the two subclasses of the designated association class.

Moreover, the data processing device 220 can exclude a designated manner and resolve a dependency in a manner other than the designated aspect. For example, when a class “Organization” is designated, the data processing device 220 may resolve a dependency between two computer systems in a manner that does not include “Organization.” In this case as well, a plurality of manners can be designated by one class or association class.

The first optional information is used mostly when the system schema retriever 222 retrieves a system schema to generate an information acquisition procedure. The system schema retriever 222 performs retrieval so that a system element or an association between system elements specified by the first optional information is to be retrieved, and generates an information acquisition procedure determined from a path of the retrieval. In accordance with this information acquisition procedure, information is acquired from the managed system 240, whereby a dependency including entity information on the system element or the association between the system elements specified by the first optional information can be obtained. Alternatively, the system schema retriever 222 performs retrieval while excluding a system element or an association between system elements specified by the first optional information from retrieval targets, and generates an information acquisition procedure determined from a path of the retrieval. Information is acquired from the managed system 240 in accordance with this information acquisition procedure, whereby a dependency including no entity information on the system element or the association between the system elements specified by the first optional information can be obtained. Accordingly, it can be also said that the first optional information is information for designating a necessary point to pass (hereinafter, referred to as a necessary transit point) or an unnecessary point to pass (hereinafter, referred to as an unnecessary transit point) along a retrieval path when the system schema retriever 222 performs retrieval processing.

As second optional information given from the input device 210, a filter may be designated that should be applied to a result to be outputted to the output device 250. Before discussing this filter, a description will be first given of information outputted to the output device 250. When no filter exists, the information outputted to the output device 250 as an information association result is a chain of instances and association instances with the starting and end points of an instance and a class, or of instances, given from the input device 210. This chain could be a plurality of chains. One chain will be referred to as an instance context, and a plurality of chains will be referred to as an instance context group. Examples of an instance context include “a server with an identifier A, an association ‘the server A has a device eth0,’ a network interface card with an identifier eth0, an association ‘the device eth0 implements LAN protocol,’ a LAN protocol endpoint with a MAC address 11:11:11:11:11:11,” and the like. The filter information given from the input device 210 as the second optional information is information that designates a class or an association class to be outputted among classes and association classes included in an instance context or instance context group. Accordingly, when the second optional information is inputted, only part of an instance context is outputted. For example, it is assumed that a class “network interface card” is given as the second optional information from the input device 210. In this case, the information to be outputted to the output device 250 is “a network interface card with an identifier eth0.” In addition, both a class and an association class may be given. For example, a class “network interface card” and an association class “a device implements LAN protocol” may be designated. In this case, outputted is information such as “a network interface card with an identifier eth0, an association ‘the device eth0 implements LAN protocol,’” which is included in the instant context shown above as an example.

As for the description format of an instance context, an instance context is represented so that an association instance is described between instances, like “an instance A, an association instance, an instance B.” However, the description of an association instance may be omitted. For example, the instance context may be also represented as “an instance A, an instance B.”

Furthermore, as third optional information given from the input device 210, a restriction or condition may be designated as to a result to be outputted to the output device 250. This is designated as an instance or an association instance. In the case of the above example, when the input device 210 gives, for example, a condition that a network interface card with an identifier eth1 must be included in an output result, the above-mentioned instance context including the device eth0 is not determined as an information association result. Further, when the input device 210 gives such a restriction that a network interface card with an identifier eth0 must not be included in an output result as well, the above-mentioned instance context including the device eth0 is not determined as an output result.

Operation

As shown in FIG. 9, the information association request interpreter 221 interprets the content of a request given from the input device 210 and, in order to acquire an information acquisition procedure corresponding to the request, issues an information acquisition procedure retrieve instruction to the information acquisition procedure retriever 223 (Step S1). Incidentally, request contents and information acquisition procedures are managed in association with each other. For example, as described already, identification information corresponding to request content is attached to an information acquisition procedure. As a specific example, identification information indicating procedure's correspondence to a “request to resolve a dependency between a server and a switch” is attached to an information acquisition procedure “server, network interface card, port on switch, switch.” When the “request to resolve a dependency between a server and a switch” is inputted, for example, it suffices that the information association request interpreter 221 issues an instruction to retrieve the information acquisition procedure to which the corresponding identification information is attached. The information acquisition procedure retriever 223 retrieves the information acquisition procedure based on the retrieve instruction received from the information association request retriever 221 (Step S2). The information acquisition procedure retriever 223 then determines whether or not the information acquisition procedure to be retrieved has been stored in the information acquisition procedure storage section 232 (Step S3).

When the information acquisition procedure to be retrieved is not stored in the information acquisition procedure storage section 232 and therefore the information acquisition procedure retriever 223 cannot acquire the information acquisition procedure (Step S3: N), the information association request interpreter 221 issues a retrieve instruction to the system schema retriever 222 and generates the information acquisition procedure (Step S4). At this time, the retrieve instruction includes information about the starting and end points of the retrieval (retrieval starting and end points in a system schema). The correspondence between the starting and end points and the format of a request from the input device 210 is as follows. When an information association request of the first request format is inputted, two instances are inputted. Since an instance is a class with the addition of entity information (see FIGS. 6A and 6B), the classes can be specified based on the instances. Therefore, it suffices that the information association request interpreter 221 issues a retrieve instruction while appointing one of the two classes specified based on the two instances as the starting point of the retrieval in a system schema and the other as the end point. When an information association request of the second request format is inputted, one instance and one class are inputted. In this case, it suffices that the information association request interpreter 221 issues a retrieve instruction while appointing a class specified based on the instance as the starting point of the retrieval in a system schema and the inputted class as the end point.

In addition, when the starting and end points are appointed, classes compatible with the inputted class and with the class specified based on the instance may be appointed as the starting and end points. In this case, the information association request interpreter 221 needs to explicitly manage information on the compatibility between classes (for example, by means of table management). For example, it is assumed that the information association request interpreter 221 stores information such that “a class ‘server’ is compatible with a class ‘ComputerSystem.’” In this case, if the class specified based on the instance (or the inputted class) is a class “server,” a class “ComputerSystem” may be appointed as the starting or end point instead of the class “server.”

Moreover, the retrieve instruction issued by the information association request interpreter 221 to the system schema retriever 222 may contain, as an option, a necessary transit point, which needs to be passed in the retrieval, or an unnecessary transit point, which does not need to be passed. This option is specified based on the first optional information among pieces of information given as options from the input device 210. With this optional information being given, the information acquisition procedure reflecting the first optional information is stored in the information acquisition procedure storage section 232. The information (a class or an association class) regarded as a necessary transit point in the retrieval is designated by the first optional information. The information (a class or an association class) regarded as an unnecessary transit point is also designated by the first optional information. For example, it is assumed that a request is received to solve a dependency between a server with an identifier A and a firewall based on network connectivity but not to include information about an OS in a dependency to be outputted. In this case, a “Server” class is set as the element name of the starting point of the retrieval and a “Firewall” class is set as the element name of the end point of the retrieval. Further, a “NetworkConnection” association class is set as the element name of a transit point and an “OperatingSystem” class is set as the element name of a non-transit point, and then a system schema retrieve instruction is generated. As a result, among a plurality of information acquisition procedures starting from “Server” and ending at “Firewall,” a procedure that includes “NetworkConnection” somewhere in the procedure is generated, but a procedure that includes “OperatingSystem” is not generated.

The system schema retriever 222 that has received a system schema retrieve instruction executes retrieval on the system schema storage section 231 and, based on a result of this retrieval, generates at least one information acquisition procedure (Step S4). The system schema retriever 222 stores the generated information acquisition procedure in the information acquisition procedure storage section 232. The information acquisition procedure creation processing at Step S4 will be described later.

After the information acquisition procedure has been generated, the information association request interpreter 221 generates an information acquisition procedure retrieve instruction to the information acquisition procedure retriever 223. Based on this instruction, the information acquisition procedure retriever 223 retrieves the information acquisition procedure (Step S2). A retrieval result is returned to the information association request interpreter 221. The information association request interpreter 221 interprets this information acquisition procedure (Step S5). The information association request interpreter 221 sends an information acquisition procedure execute instruction corresponding to the interpreted procedure to the information acquisition procedure executer 224.

Based on the received information acquisition procedure execute instruction, the information acquisition procedure executer 224 sequentially executes the acquisition of information from the managed system 240 (Step S6). The information acquisition processing (Step S6) according to the information acquisition procedure will be described later. Note that, among the pieces of information given from the input device 210, the third optional information is used by this information acquisition procedure executer 224.

A result of the execution at Step S6 is returned to the information association request interpreter 221. The information association request interpreter 221 then determines whether or not a result of the information acquisition from the managed system 240 exists (Step S7). When a result of the information acquisition from the managed system 240 exists (Step S7: Y), the information association request interpreter 221 allows the output device 250 to output this information acquisition result (Step S8). When a result of the information acquisition from the managed system 240 does not exist (Step S7: N), the information association request interpreter 221 allows the output device 250 to output information to the effect that no information could be acquired from the managed system 240 (Step S9).

Among the pieces of optional information given from the input device 210, the second optional information concerning filtering of an output result may be used in the processing at Step S8. The information association request interpreter 221 performs determination processing sequentially on a plurality of instance contexts given from the information acquisition procedure executer 224, as to whether or not an instance context matches a filter that is given. The information association request interpreter 221 then allows the output device 250 to output matching part of information included in the individual instance contexts.

Information Acquisition Procedure Creation

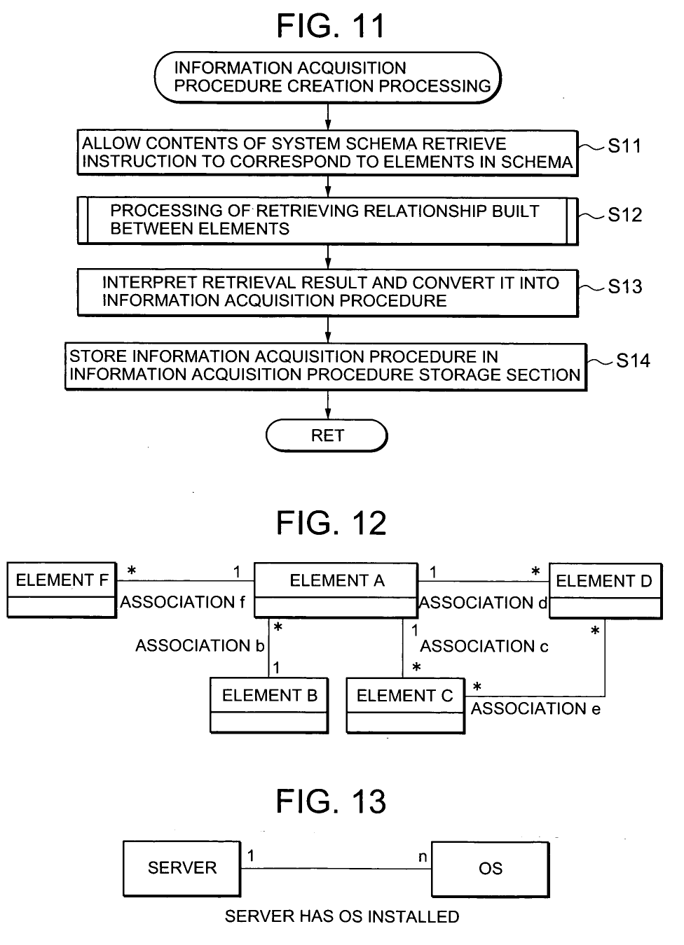

FIG. 11 shows the information acquisition procedure creation processing at Step S4. Here, a description will be given of the case as an example where a system schema represented by a UML class diagram as shown in FIG. 12 is stored in the system schema storage section 231.

The information association request interpreter 221 allows the contents of a system schema retrieve instruction, such as the starting and end points of the retrieval, to correspond to elements in the system schema (Step S11). That is, among the elements in the system schema, elements to be the starting and end points of the retrieval are determined. In this example, it is assumed that, in the system schema shown in FIG. 12, an element A is set as the starting point of the retrieval and an element C is set as the end point of the retrieval. Thereafter, the information association request interpreter 221 outputs a retrieve instruction including information on the starting and end points of the retrieval to the system schema retriever 222.

Next, the system schema retriever 222 retrieves a relationship established between the elements set as the starting and end points at Step S11 (Step S12). In this Step S12 to retrieve a relationship established between the elements, used is a blind all-path search algorithm or a heuristic multi-path search algorithm. However, a restriction may be imposed on a search direction between the elements by describing multiplicity along with an association element (an element representing an association between system elements). The “multiplicity” is a value indicating the number of associations when one element is associated with the element itself or with another element. In other words, the “multiplicity” can be said to be the number of instances (the number of entities) of an element to be associated when one element is associated with the element itself or with another element.

FIG. 13 shows a specific example of the multiplicity. It is assumed that an element “server” and an element “OS” are present in a system schema. These two elements are associated with each other by an association element “server has OS installed and OS is installed in server.” At this time, if attention is focused on the OS, the OS is installed in only one server (i.e., there is only one instance of the server in which the OS is to be installed.) Therefore, “1” is the multiplicity when the OS is associated with the server. Note that a multiplicity is added to a side of an element associated with an element of interest. In the above example, the OS is receiving attention, and therefore the multiplicity “1” is added to a side of the element (server) with which the OS is associated. Next, when attention is focused on the server, the server can install a plurality of OSs. It is assumed that “n” (“n” is a natural number) is the upper limit of the number of OSs that can be installed in the server. In this case, the server can install a maximum of n OSs, and the number of instances of the OS to be installed in the server is “n.” Therefore, “n” is the multiplicity when the server is associated with the OS.

If such multiplicity is determined in a system schema, a restriction as below may be imposed in the retrieval processing at Step S12 of FIG. 11. Specifically, in a search in a way of sequentially following associated elements, if “n” is the multiplicity when some element (assumed to be an element P) is associated with another element (assumed to be an element Q), a restriction may be imposed such that following a path from the element Q to the element P and then returning to the element Q should be repeated only up to “n−1” times. That is, it may be prohibited to perform such a returning operation as to search for the element P from the element Q and thereafter again search for the element Q the multiplicity-indicating number of times or more. For example, since “1” is the multiplicity when the OS is associated with the server, a repetition of following a path from the server to the OS and then returning to the server is not allowed because 1−1=0. The reason is that conducting such a search as to follow a path from the server to the OS and then return to the server will be redundant when there is only one instance of the server. That is, an information acquisition procedure will resultantly include a plurality of steps of acquiring entity information on the same server, which leads to redundancy. In addition, assuming that “n” is the multiplicity when the server is associated with the OS, it is allowed to repeat following a path from the OS to the server and then returning to the OS up to n−1 times. This is because, if the returning operation of going back to the OS after following a path from the OS to the server is performed n times or more when there is only n instances of the OS, then an information acquisition procedure will resultantly include the steps of acquiring entity information on the OS in the same number as the instances or more, which leads to redundancy.

Incidentally, the case of no restriction on multiplicity will be denoted by “*.” The case of a multiplicity of “0” is also included in the representation “*.” The case of a multiplicity that is “not less than n and not more than m” will be denoted by “n . . . m.” For example, a multiplicity of “0 . . . 1” indicates that the multiplicity is “not less than 0 and not more than 1.”

A description will be given of a search based on this multiplicity, using the example of the system schema shown in FIG. 12. In the following description, entity information of a system having the class of the element A in the system schema shown in FIG. 12 and also including an identifier will be denoted by a1, a2, and so on. Similarly, entity information of systems that have the classes of elements B and C, respectively, and also include respective identifiers will be denoted by b1, . . . and c1, . . . , respectively. When searching for a path between the elements A and C in FIG. 12, the system schema retriever 222 outputs the following four paths as retrieval results:

(element A-association c-element C);

(element A-association d-element D-association e-element C);

(element A-association b-element B-association b-element A-association c-element C); and

(element A-association b-element B-association b-element A-association d-element D-association e-element C).

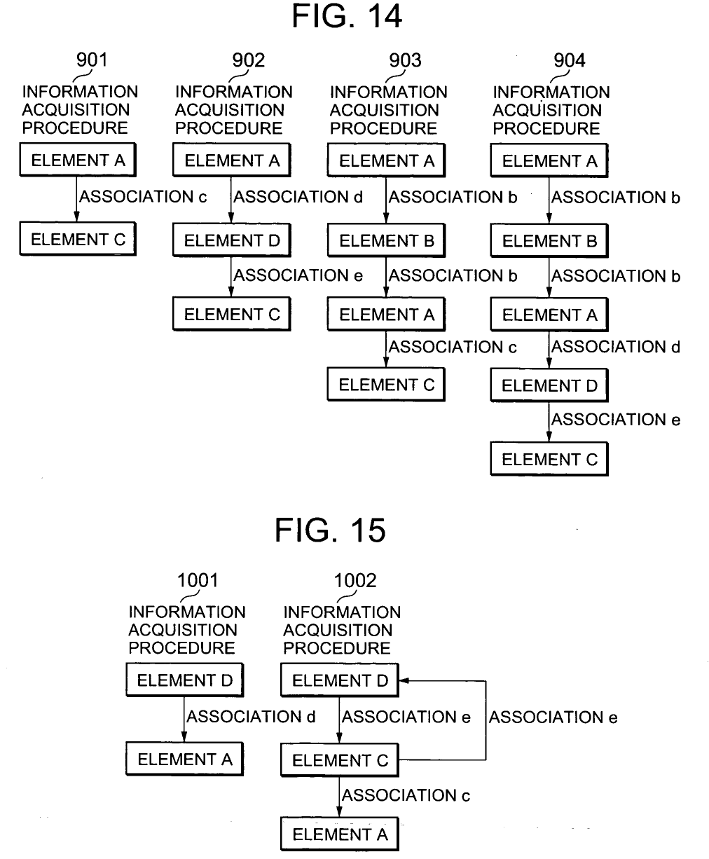

Subsequently, based on the retrieval results, the system schema retriever 222 generates an information acquire procedure from each retrieval result (Step S13). An example of each information acquisition procedure generated at Step S13 will be shown in FIG. 14.

In FIG. 14, information acquisition procedures 901 to 904 are the information acquisition procedures generated from the above-mentioned four retrieval results, respectively. For example, the information acquisition procedure 901 indicates a procedure of starting from the element A, following the association c, and acquiring information on the element C. Additionally, since the multiplicity of the association b has no limit with respect to the element A but has an upper limit of 1 with respect to the element B, a returning operation of (element A-association b-element B-association b-element A) is permitted, but a returning operation of (element B-association b-element A-association b-element B) is prohibited. As for the element F, since such a search as to reach the element F from the element A and return to the element A again is not permitted, such a path is not included in the retrieval results and therefore is not generated as an information acquisition procedure.

As shown in FIG. 15, in the case where the starting point of the retrieval is the element D and the end point of the retrieval is the element A, information acquisition procedures 1001 and 1002 are generated. Among these information acquisition procedures, the information acquisition procedure 1002 includes a procedure of (element D-association e-element C-[association e-element D-association e-element C-] association c-element A). In this procedure, the square brackets [ ] indicates that the array within the square brackets [ ] is repeated. In the information acquisition procedure including this repetition, after the element C is acquired by following the association e from the element D with an identifier d1, the element D may be acquired by following the association e, or the element A may be acquired by following the association c. In addition, in processing concerning the element C, which is the last part of the repetition, the element D may be acquired by following the association e from the element C with an identifier c1, or the element A may be acquired by following the association c.

When the information acquisition procedures have been generated from the results of the retrieval of paths between the two elements, the system schema retriever 222 stores the information acquisition procedures in the information acquisition procedure storage section 232 (Step S14). Note that, at this time, the system schema retriever 222 adds identification information to each of the generated information acquisition procedures. This identification information indicates procedure's correspondence to a request inputted from the input device 210. When the same request is inputted again, it suffices to retrieve an information acquisition procedure by using this identification information as a key.

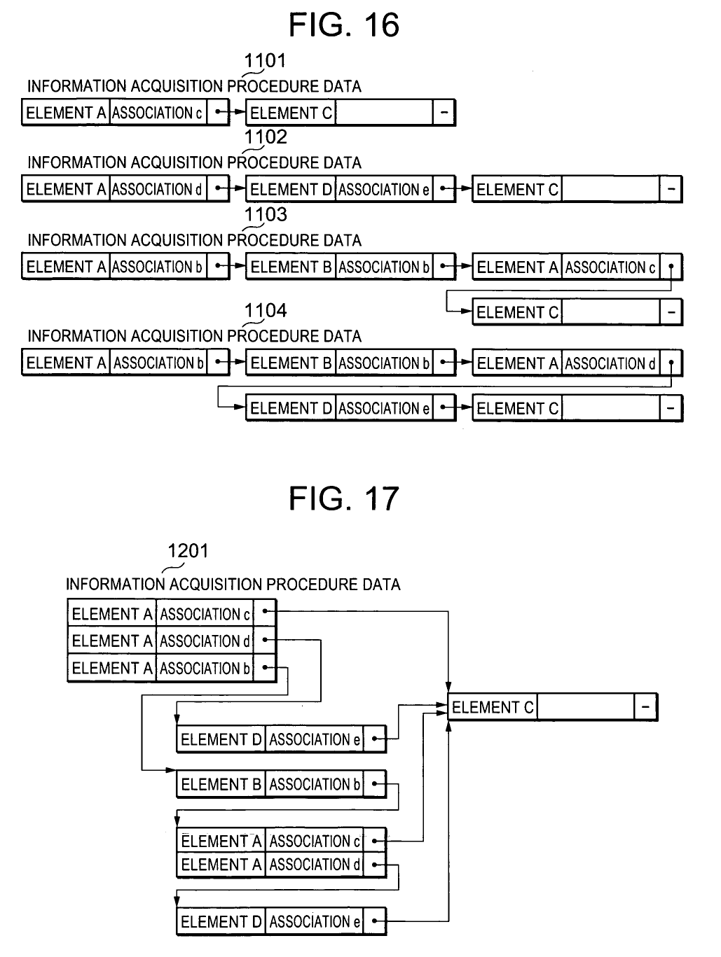

Next, a description will be given below of examples of formats of data generated as the above-described path retrieval results and information acquisition procedures. A first example of the data structure is a structure in which each of the plurality of information acquisition procedures is stored in list form with link. A second example of the data structure is a structure in which all the plurality of information acquisition procedures are stored in one table form with link. Examples will be shown in FIG. 16, FIG. 17 and FIG. 18.

As shown in FIG. 16, in the first example of the data structure, the information acquisition procedures 901 to 904 shown in FIG. 14 are stored in a data structure like information acquisition procedure data sets 1101 to 1104, respectively. That is, the plurality of information acquisition procedures are individually stored as the respective information acquisition procedure data sets 1101 to 1104.

As shown in FIG. 17, in the second example of the data structure, the information acquisition procedures 901 to 904 are stored in a data structure like an information acquisition procedure data set 1201. That is, the plurality of information acquisition procedures are stored as the one information acquisition procedure data set 1201.

Additionally, as shown in FIG. 18, a procedure including a repetition like the information acquisition procedure 1002 (see FIG. 15) is stored in a data structure like an information acquisition procedure data set 1301.

Note that, when the first optional information is designated by the input device 210 and a system schema retrieve instruction, along with a necessary transit-point element, is given from the information association request interpreter 221, the system schema retriever 222 may delete a path that does not include the necessary transit-point element from the paths obtained as retrieval results. Alternatively, the system schema retriever 222 may execute processing similar to the processing of searching for a path connecting the starting point to the end point, for each of a path from the starting point to the necessary transit-point element and a path from the necessary transit-point element to the end point. In addition, when an unnecessary transit-point element is given along with the system schema retrieve instruction, the system schema retriever 222 may delete a retrieval result that includes the unnecessary transit-point element. Alternatively, when the unnecessary transit-point element is given, the system schema retriever 222 may search for a path while avoiding the unnecessary transit-point element at the time of retrieval execution.

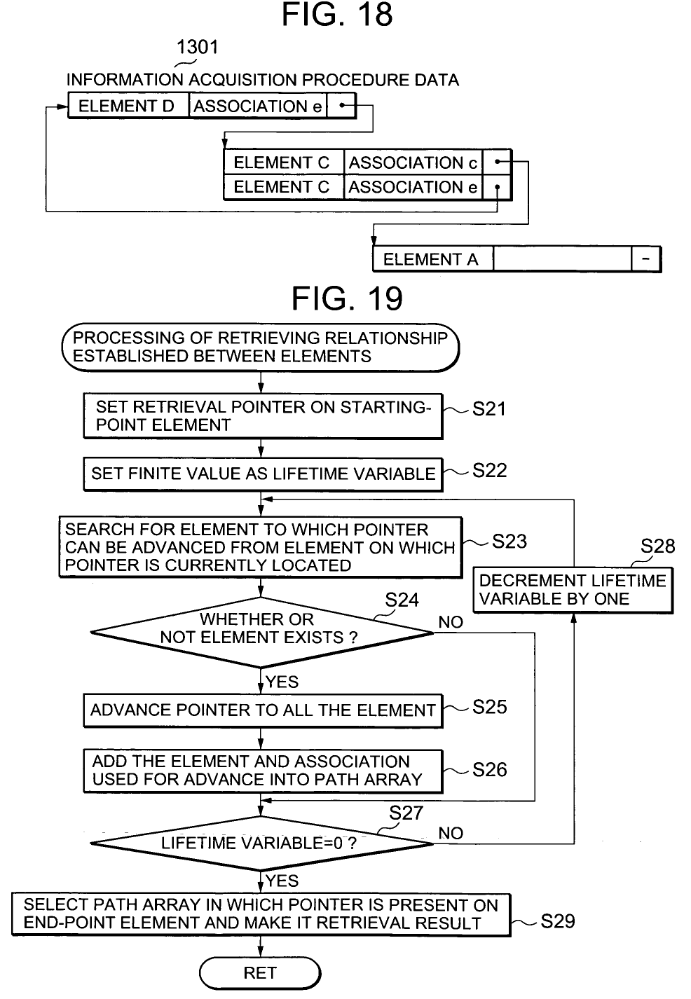

The processing of retrieving a relationship established between elements (Step S12) may be performed by using some method of blind all-path search. Here, as an example of the blind all-path search method, a description will be given of a method of breadth-first all-path search with the provision of a given retrieval-lifetime variable, with reference to a flowchart shown in FIG. 19.

The system schema retriever 222 first sets a retrieval pointer on an element given as the starting point of the retrieval (Step S21). In the above-described example in which the element A is the starting point, the pointer is set on the element A. Next, a finite value is set as a lifetime variable (Step S22). The initial value of the lifetime variable given at Step S22 defines the number of times the undermentioned repetition processing from Step S23 to Step 27 is performed.

Subsequently, the system schema retriever 222 enumerates all the elements to which the pointer can be next advanced from the element on which the retrieval pointer is currently located (Step S23). In Step S23, the retrieval pointer is advanced to an element that is associated with the element on which the retrieval pointer is currently set. There are some cases where the element on which the retrieval pointer is currently set is associated with the element itself. In addition, when the retrieval pointer is set on the end-point element, if the end-point element is associated with the element itself, then it is determined that further retrieval is possible. For example, “LANEndpoint” shown in FIG. 8 is associated with “LANEndpoint” itself. In this case, it is determined that it is possible to further retrieve “LANEndpoint” even when “LANEndpoint” is the end-point element and the retrieval pointer is set on “LANEndpoint.” As a result, a search path will continue, like “ . . . , LANEndpoint, LANEndpoint, LANEndpoint, . . . .” Additionally, it may be determined whether the scope of a search is restricted based on multiplicity.

Next, the system schema retriever 222 determines whether or not an element exists to which the retrieval pointer can be advanced (Step S24). When it is determined that such an element exists (Step S24: Y), the system schema retriever 222 advances the retrieval pointer to the element (Step S25). If a plurality of elements exist to which the retrieval pointer can be advanced, the retrieval pointer is advanced to all the elements. Incidentally, the retrieval pointer has a path array for recording the elements on which the search has been done. When the system schema retriever 222 advances the retrieval pointer to the plurality of elements, the system schema retriever 222 duplicates the retrieval pointer and advances the respective retrieval pointers to the plurality of elements. Then, for each of the retrieval pointers, the system schema retriever 222 adds the element to which the retrieval pointer is advanced and an association used to advance the retrieval pointer to that element, to the path array held by the retrieval pointer (Step S26). Thereafter, the control goes to Step S27.

Additionally, when it is determined at Step S24 that there is no element to which the retrieval pointer can be advanced, the control goes to Step 27.

In Step S27, the system schema retriever 222 determines whether or not the lifetime variable has become zero. When the lifetime variable has not become zero yet (Step S27: N), the system schema retriever 222 decrements the lifetime variable by one (Step S28). Thereafter, for all the elements on which the retrieval pointers are currently set, it is determined whether or not the retrieval can be further performed (Step S23). When the processing after Step S23 has been repeated the same number of times as the finite value set at Step S22, the lifetime variable becomes zero at Step S27. In this case (Step S27: Y), the system schema retriever 222 selects a path array in which the retrieval pointer is on the end-point element, and makes the path array a retrieval result (Step S29).

Information Acquisition

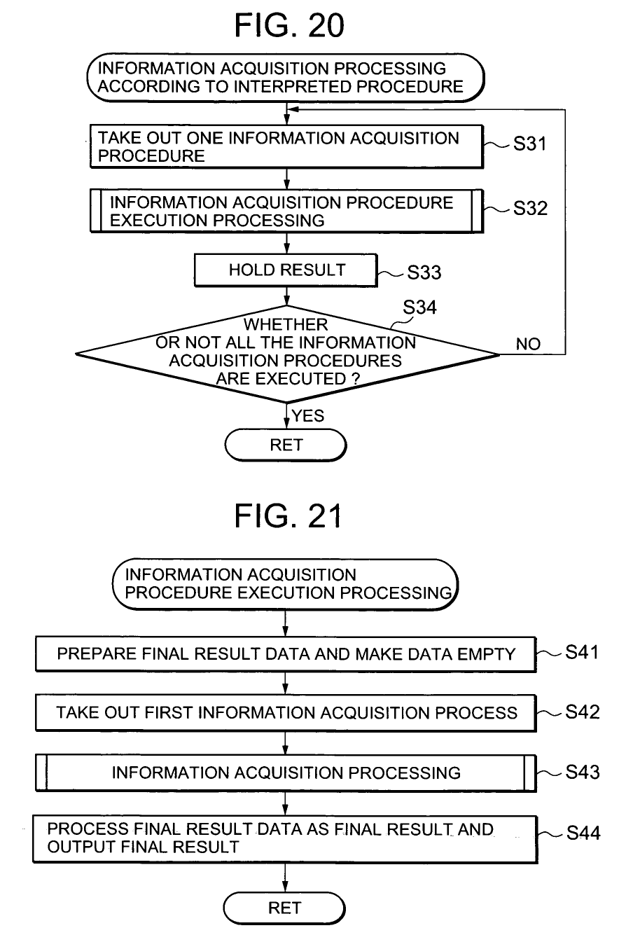

Next, the content of the processing at Step S6 (see FIG. 9) will be described with reference to FIGS. 20 to 22.

FIG. 20 is a flowchart of the information acquisition processing (Step S6) according to the information acquisition procedure. It is assumed here that the processing according to the plurality of information acquisition procedures shown in FIG. 16 will be individually performed. First, the information acquisition procedure executer 224 extracts one information acquisition procedure data set from one or more information acquisition procedure data sets received from the information association request interpreter 221 (Step S31). For example, the information acquisition procedure executer 224 selects one information acquisition procedure data set from the information acquisition procedure data sets 1101 to 1104. Subsequently, the information acquisition procedure executer 224 executes the selected information acquisition procedure (Step S32).

FIG. 21 shows the execution processing of information acquisition procedure (Step S32). It is assumed that an information acquisition procedure is composed of a series of information acquisition processes. In the information acquisition procedure execution processing (Step S32), the information acquisition procedure executer 224 first prepares, as final result data, an execution result of one information acquisition procedure, and makes the value of this data empty (Step S41). At this time, the information acquisition procedure executer 224 also prepares a result array for storing an instance given from the input device 210 and an instance obtained as a result of the information acquisition processing. Next, the information acquisition procedure executer 224 takes a first information acquisition process out of the information acquisition procedure (Step S42) and executes this information acquisition process (Step S43).

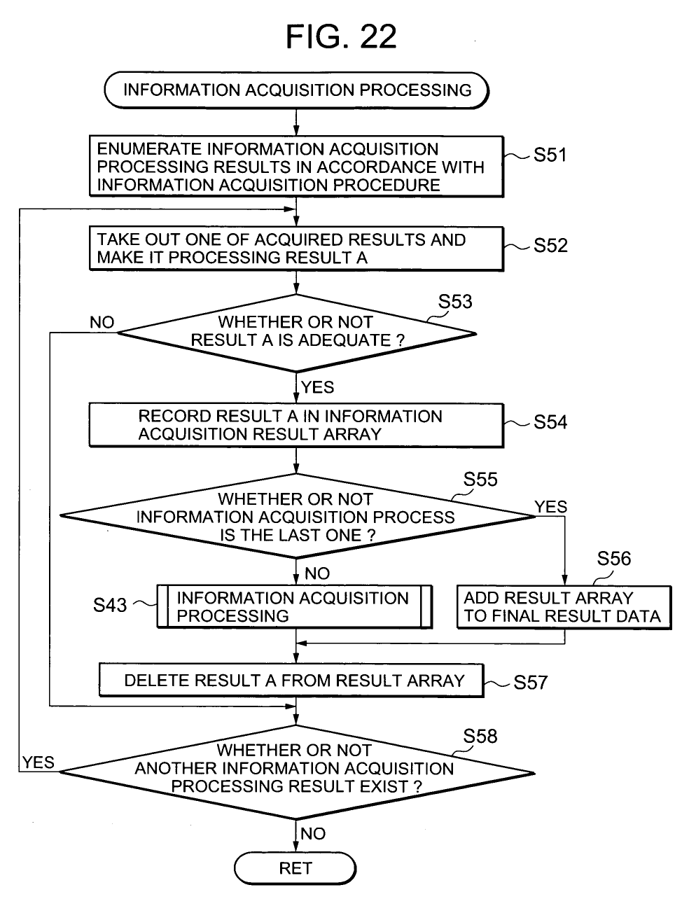

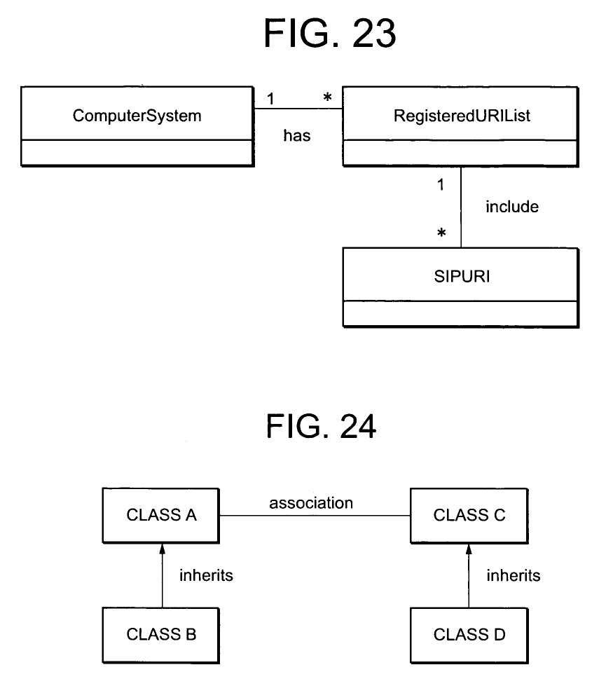

FIG. 22 shows information acquisition processing (Step S43). The information acquisition procedure executer 224 first executes the first information acquisition process to query the managed system. For example, when the information acquisition procedure executer 224 executes the first information acquisition process of the information acquisition procedure data set 1101 shown in FIG. 16, the information acquisition procedure executer 224 acquires system information having the type of the element C by following the association c from system information a1 having the class of the element A given from the input device 210. If a plurality of acquisition results exist here, all the acquisition results are enumerated (Step S51). For example, when c1 and c2 are acquired as acquisition results, these c1 and c2 are enumerated. The information acquisition procedure executer 224 selects one of the acquisition results (here, assumed to be c1) and takes it as a processing result A (Step S52).

Next, the information acquisition procedure executer 224 determines whether or not the result A is appropriate (Step S53). This determination processing is performed mainly based on the third optional information given from the input device 210. More specifically, when an instance or association instance that should not to be included in an information acquisition result has been designated and the result A applies to the case, it is determined that the result A is not appropriate. On the other hand, when the result A does not apply, it is determined that the result A is appropriate.

When the result A is appropriate, the information acquisition procedure executer 224 records the result A in the information acquisition result array (Step S54). Next, the information acquisition procedure executer 224 determines whether or not this information acquisition process is the last information acquisition process of the information acquisition procedure (Step S55). When it is determined at Step S55 that the information acquisition process in question is the last one (Step S55: Y), the information acquisition procedure executer 224 outputs the result array to the final result data (Step S56). In the aforementioned example, since the first information acquisition process is also the last information acquisition process in the information acquisition procedure data set 1101, the information acquisition procedure executer 224 outputs, as a result, a1, c1 and an association instance indicating that it connects a1 and c1. Next, the information acquisition procedure executer 224 deletes the result A from the information acquisition result array (Step S57) and then determines whether or not another information acquisition result exists (Step S58).

As a result, if another information acquisition result exists, the information acquisition procedure executer 224 selects this other result at Step S52, takes it as a result A again, and repeats similar processing. In the aforementioned example, apart from c1, c2 is acquired. Therefore, c2 is made a processing result A and stored in the information acquisition result array. This is also outputted to the final result data.

When the processing after Step S52 has been performed on all the information acquisition results, the step of executing the information acquisition processing is terminated (Step S43, see FIG. 21). The final result data at this point is made a finally obtained result (Step S44, see FIG. 21). Note that, in this Step S44, a retrieval result may be deleted depending on the format of a request given from the input device 210. That is, in the case of the first request format in which two instances are given, the step may include processing in which, when an instance obtained through the last information acquisition process of the information acquisition procedure does not match the instance given from the input device, the obtained instance is not made a retrieval result. Moreover, the processing concerning the third optional information designated by the input device 210 may be added to this step. That is, when an instance or association instance that needs to be included in an information acquisition result is designated, the processing of excluding an information acquisition result that does not include the instance may be included in Step S44.

The information acquisition procedure executer 224 holds the final result data thus acquired (Step S33, see FIG. 20). After Step S33, the information acquisition procedure executer 224 determines whether or not all the information acquisition procedures are executed (Step S34). If an information acquisition procedure that has not been executed yet is left, the information acquisition procedure executer 224 selects one information acquisition procedure that has not been executed yet and repeats the processing after Step S31. In the case of the aforementioned examples of the information acquisition procedures prepared to resolve a dependency between the elements A and C, the information acquisition procedure executer 224 sequentially takes out each of the information acquisition procedures 902 to 904 shown in FIG. 14 and executes the processing after Step S31 on each of them.

Here, it is assumed that, in the case of the information acquisition procedure 902, d1 is acquired by executing information acquisition processing of starting from a1, following the association d, and acquiring the element D. Further, it is assumed that c1 is acquired by executing information acquisition processing of starting from d1, following the association e, and acquiring the element C. Furthermore, it is assumed that, in the case of the information acquisition procedures 903 and 904 each, no acquisition result can be acquired through the information acquisition processes in the information acquisition procedure. In this case, the final result data held at Step S33 in FIG. 20 are as follows: (a1, an association instance referring to a1 and c1, c1); (a1, an association instance referring to a1 and c2, c2); and (a1, an association instance referring to a1 and d1, d1, an association instance referring to d1 and c1, c1). The information acquisition procedure executer 224 outputs all of these to the information association request interpreter 221 as results. The information association request interpreter 221 sends these results to the output device 250. Note that, when the third optional information is designated by the input device 210 and d1 is designated as an instance that needs to be included in an information acquisition result, the result (a1, an association instance referring to a1 and d1, d1, an association instance referring to d1 and c1, c1) is sent to the output device 250. Moreover, when the second optional information is designated and it is designated that only an instance having the class of the element C should be returned to the output device 250, then c1 and c2 are outputted.

Next, a description will be given of the processing including branches or repetition like the information acquisition procedure 1002 shown in FIG. 15. It is assumed that the information acquisition procedure 1002 is stored in the information acquisition procedure storage section 232, in the data form represented like the information acquisition procedure data set 1301 shown in FIG. 18. Moreover, it is assumed that an association request from the input device 210 requests that an instance d1 corresponding to the element D and an instance a1 corresponding to the element A be associated with other information. In this case, as the first information acquisition process, the information acquisition procedure executer 224 takes a process of acquiring entity information on the element C from the element D and the association e, out of the information acquisition procedure data set 1301 (Step S42, see FIG. 21). The information acquisition procedure executer 224 then executes this process and acquires an instance c1 (Step S51, see FIG. 22). Next, the information acquisition procedure executer 224 takes this instance c1 as a result A (Step S52) and stores this result in the result array. Here, the instances d1 and c1, and an association instance indicating that there is a relationship between the instances d1 and c1 are present in the result array.

Next, it is determined whether or not the current process is the last information acquisition process. From the information acquisition procedure data set 1301, it is found that this is not the last process (Step S55: N). Therefore, the next information acquisition process is executed (Step S43). This step is recursively called. The information acquisition procedure executer 224 recursively calls the processing of Step S43 and executes the next information acquisition process by starting from the instance c1. Then, in this example, enumerated are the instance a1 corresponding to the element A and an instance d2 corresponding to the element D (Step 51). Of these instances, the information acquisition procedure executer 224 selects the instance a1 and takes it as an acquisition result A (Step S52). Since this result A is appropriate and this process is the last information acquisition process, the information acquisition procedure executer 224 outputs the result array, which is an array including d1, c1, a1, and association instances each indicating that there is a relationship between them, to the final result data (Step S56). Thereafter, the information acquisition procedure executer 224 deletes the result A from the result array (Step S57) and selects the instance d2, which is another information acquisition processing result. This instance d2 will be the next result A. It is assumed that this result A made of the instance d2 is appropriate. Since this current process is not the last information acquisition process, the processing of acquiring the element C from the element D and the association e is performed as the next information acquisition process.

As described above, the information acquisition processes are sequentially executed on the managed system, in accordance with the procedure stored in the information acquisition procedure data, by using depth-first search based on a backtracking algorithm, or the like.

Incidentally, twice acquiring the same information on the managed system can be avoided by determining that a result is not appropriate at Step S53, where the appropriateness of an information acquisition processing result is determined, when a result already included in the result array is acquired. In addition, there is a possibility that a loop in an information acquisition procedure is repeated if the managed system is sufficiently large. In this case, it is effective to set a lifetime variable for the information acquisition procedure execution processing and thus to limit the number of times the information acquisition processing is performed.

As an aside, examples of a specific method for the information acquisition processing include, for example, information acquisition using SNMP, CIM Operations over Http for WBEM, and others.

Addition of System Element

Next, a description will be given of the addition to a system schema when a new system element is added to a managed system. It is assumed that a new system element is added to a managed system and that the system element is not represented in any system schema stored in the system schema storage section 231. In this case, to generate a procedure of acquiring entity information on the added system element, it suffices to change a system schema so as to represent the added system element.

For example, it is assumed that a SIP server is added to a managed system. In this case, it suffices to add a class representing the SIP server to a system schema. The SIP server has zero or more registered URL lists, and each list includes zero or more SIPURLs. Accordingly, it suffices to add a class representing this fact to the system schema.

FIG. 22 shows an example of a system schema representing “having zero or more registered URL lists, each list including zero or more SIPURLs.” Such a system schema is combined with an existing system schema, thereby obtaining a new system schema. Thus, even when the computer network management system manages a network system including a SIP server, the computer network management system can generate an information acquisition procedure to resolve a dependency.

Conventionally, when a new system element was added to a managed system, a scenario, which is a kind of program, had to be generated. Therefore, the burden on a system administrator became heavier. In the present invention, however, it suffices to add a system schema representing the new system element. Since adding a system schema is easier than creating a scenario, the burden on a system administrator can be reduced.

According to the present invention, it is possible to resolve a dependency between system elements for a system administrator who needs to grasp the dependency when constructing a system, operating a system, changing a system configuration, or the like. Hence, it is possible to provide a dependency desired by the system administrator.

Moreover, according to the present invention, an information acquisition procedure corresponding to an information association request is generated from a system schema describing the concept of a network system, and this information acquisition procedure is executed. Therefore, it is possible to save a system administrator or system management application creator from creating an information acquisition procedure. Furthermore, since an information acquisition procedure is generated depending on an information association request, it is also possible to achieve such an effect that the types of system information obtained as a dependency are not restricted.

In addition, according to the present invention, when a system schema creator sets a multiplicity on association, an information acquisition procedure is generated based on the multiplicity. Therefore, it is possible to avoid creating a redundant information acquisition procedure.

Note that, although the above description illustrates the case where two instances, or one instance and one class, are inputted from the input device 210, only entity information may be inputted instead of an instance as shown in FIG. 6B. However, a class can be specified from an instance but cannot be specified directly from entity information only. In the case where entity information only is inputted instead of an instance, it is necessary to hold a table that shows a correspondence between each piece of entity information and a class so that the table is used to specify a class from the inputted entity information.

In the above-described embodiment, system schema storing means is realized by the system schema storage section 231. Information acquisition procedure creating means is realized by the system schema retriever 222. Element designating means, association designating means and condition designating means are realized by the information association request interpreter 221 and the input device 210. Information acquiring means is realized by the information acquisition procedure executer 224. Output means is realized by the information association request interpreter 221 and the output device 250. System schema selecting means is realized by the information association request interpreter 221.

Additionally, the data processing device 220 operates in accordance with a computer network management program. The computer network management program is to be installed in a computer which includes the system schema storing means for storing a system schema that describes the configuration of a computer network system by modeling elements and associations between the elements included in the computer network system, in a predetermined representation format. The computer network management program is a program instructing the computer to execute the processing of creating an information acquisition procedure to acquire, from the managed computer network system, information indicative of elements connecting two inputted elements and of associations between the elements, based on information about the two inputted elements and on the system schema, when the information about the two elements, among elements included in the managed computer network system, is inputted to the computer.

2. Second Embodiment

Next, a second embodiment of the present invention will be described. The configuration of a computer network management system according to the second embodiment is substantially the same as that of the first embodiment (see FIG. 7). However, in the first embodiment, elements have no inheritance relationship in a system schema to be stored beforehand in the system schema storage section 231.

In contrast, in the second embodiment, the system schema storage section 231 stores a system schema including elements that have an object-oriented inheritance relationship.

FIG. 24 shows an example of such a system schema. In the system schema shown in FIG. 24, a class B inherits from a class A. A class D inherits from a class C. Additionally, the classes A and C are in association with each other.

In the case of a system schema including elements that have an inheritance relationship established between them, the processing at Step S23 (i.e., the processing of searching for an element to which the retrieval pointer can be advanced from an element on which the retrieval pointer is currently set, see FIG. 19) is different from that of the first embodiment. The other processing steps are similar to those of the first embodiment. For simplicity, an element on which the retrieval pointer is currently set will be referred to as a currently pointer set element.

In the first embodiment, in the processing of searching for an element to which the retrieval pointer can be advanced from a currently pointer set element (Step S23 in FIG. 19), the retrieval pointer is advanced to an element that is in association with the currently pointer set element.

In contrast, in the second embodiment, the retrieval pointer is advanced to the following elements which are regarded as elements to which the pointer can be advanced: an element that is in association with another element from which the currently pointer set element inherits, and an element that inherits that element.

FIG. 24 shows the processing of searching for an element to which the retrieval pointer can be advanced from the currently pointer set element. It is assumed that the retrieval pointer is currently set on the class B shown in FIG. 24. The system schema retriever 222 enumerates all the elements from which a currently pointer set element inherits (Step S71). In the example shown in FIG. 24, since the class B on which the retrieval pointer is currently set inherits from the class A, the class A is enumerated. If the class B also inherits from elements other than the class A, the elements are enumerated. A super class (parent class) of the element on which the retrieval pointer is currently set is also included in those elements to be enumerated at Step S71.

Subsequently, the system schema retriever 222 enumerates an element that is in association with each element enumerated at Step S71 (Step S72). In the above example, since the class A is enumerated at Step S71, an element (class C) that is in association with the class A is enumerated. Although this example shows the case of enumerating only the class C that is in association with the class A, if there are classes other than the class C that are in association with the class A, these classes are enumerated. In addition, if classes other than the class A are enumerated at Step S71, classes that are in association with each of the other classes are also enumerated.

Further, the system schema retriever 222 enumerates an element that inherits from the element enumerated at Step S72 (Step S73). In the above example, since the class C is enumerated at Step S72, the class D, which inherits from the class C, is enumerated. If classes other than the class C are enumerated at Step S72 as well, classes that inherit from each of the other classes are also enumerated. A subclass (child class) of the element enumerated at Step S72 is also included in those elements to be enumerated at Step S73.

The system schema retriever 222 regards those elements enumerated at Steps S72 and S73 as being in association with the element on which the retrieval pointer is currently set (Step S73). Moreover, this association is regarded as an association identical to the association between the element from which the currently pointer set element inherits and each element enumerated at Step S72. In the case of the above example, the elements (class C, class D) enumerated at Steps S72 and S73 are regarded as having an association with the class B on which the retrieval pointer is currently set. At this time, the association with the class B is regarded as identical to the association between the class A from which the class B inherits and the class C enumerated at Step S72.

The system schema retriever 222 then advances the retrieval pointer to each of the elements enumerated at Steps S72 and S73.

According to this embodiment, it is possible for a system schema designer to design a system schema including elements that have an inheritance relationship, based on object orientation, resulting in the reduced burden on designing. If modeling is performed without using object orientation, for example, by treating a web server and a HTTP server as completely separate elements, a function common to servers needs to be designed for both elements.

In contrast, if modeling is performed using object orientation, it is possible to collectively design the common function for a more comprehensive element that is a superior concept, i.e., a server. If a more comprehensive element, such as a server, and a less comprehensive element, such as a web server or HTTP server, are separated from each other with thereafter providing an inheritance relationship to them, a function common to a plurality of system elements can be collectively described in one element. Consequently, the burden on designing can be reduced.

### EXAMPLE 1

Next, an example of the present invention will be described. In this example, it is assumed that the data processing device 220 is a computer operating in accordance with a program and the data storage device 230 is a magnetic disk device or the like.

The system schema storage section 231 stores a system schema based on CIM. In this example, it is assumed that the system schema storage section 231 stores a system schema represented by the UML class diagram as shown in FIG. 8. Moreover, it is assumed that a managed system has a configuration as shown in FIG. 26.

As shown in FIG. 26, the managed system includes switches 2210 and 2220. The switch 2210 is provided with ports 2211 to 2214. The switch 2220 is provided with ports 2221 to 2226. As for the switch 2220, a firewall 2231, a server 2232, a server 2233, a firewall 2234, and a network 2240 are connected to the ports 2221 to 2225, respectively. As for the switch 2210, a load balancer 2235 is connected to the port 2214. As for a connection between the switches, the port 2211 of the switch 2210 is connected to the port 2226 of the switch 2220.

In addition, it is assumed that a port VLAN1 is assigned to the ports 2214, 2211, 2226, and 2222 and a port VLAN2 is assigned to the ports 2221 and 2225. Additionally, in the configuration shown in FIG. 26, a management server 2260 is a computer network management system according to the present invention. A server 2250 is a server implementing WBEM, which acquires information from the managed system for the management server 2260.

Considering that an information association request to acquire a dependency established between the server 2233 and the firewall 2231 is given to the information association request interpreter 221 through the input device 210 of the management server 2260. In FIG. 26, the information association request interpreter 221 and the input device 210 are not shown. The format of this information association request is the first request format. This information association request has the content that is to be requested when, for example, the server 2233 and the firewall 2231 need to be connected for VLAN. In addition, it is assumed that the information association request contains such information that information about ports of a switch will need to be contained in information about the dependency to be obtained as an output result. This corresponds to the first optional information.

The information association request interpreter 221 determines that, in the system schema shown in FIG. 8, the starting point is a “ServerComputerSystem” class, the end point is a “FirewallComputerSystem” class, and a necessary transit-point class is a “SwitchPort” class. It is assumed that this determination is made because the server 2231 has the “ServerComputerSystem” class and the firewall 2231 has the “FirewallComputerSystem” class. The information association request interpreter 221 then sends a system schema retrieve instruction to the system schema retriever 222 (not shown in FIG. 26). It is assumed that the system schema retriever 222 performs breadth-first search.

The system schema retriever 222 sets a retrieval pointer on the “ServerComputerSystem” class, which is the starting point of the retrieval, and makes it a first retrieval pointer. In addition, it is assumed that the lifetime variable is set to 15 in this example. The system schema retriever 222 searches for a class that is associated with the first retrieval pointer, and acquires a “ServerEthernetPort” class and an “OperatingSystem” class. For each of the acquired classes, the system schema retriever 222 determines whether or not the retrieval can be advanced. The system schema retriever 222 then sets second and third pointers on the “ServerEthernetPort” class and the “OperatingSystem” class, respectively. Here, (ServerComputerSystem, ServerSystemDevice, ServerEthernetPort) is stored as a path array that the second retrieval pointer has. Moreover, (ServerComputerSystem, RunningOS, OperatingSystem) is stored as a path array that the third retrieval pointer has. At this time, the retrieval-lifetime variable becomes 14.

When a further search for a class that is associated with the second retrieval pointer is made, “ServerComputerSystem” and “LANEndpoint” are found. Here, (ServerComputerSystem, ServerSystemDevice, ServerEthernetPort) is stored as the path array and the multiplicity of the “ServerSystemDevice” association class is “1” with respect to the “ServerComputerSystem” class. Accordingly, it is determined that the “ServerComputerSystem” class cannot be a candidate to be associated. As a result, at a stage of executing the information acquisition procedure on the managed system, the following unnecessary information acquisition procedure is excluded: searching for identification information of “ServerEthernetPort” from identification information of “ServerComputerSystem”; and using this result to further search for identification information of “ServerComputerSystem”. Accordingly, the retrieval pointer is advanced to the “LANEndpoint” class from the “ServerEthernetPort” class. This is made a fourth retrieval pointer. This path array becomes (ServerComputerSystem, ServerSystemDevice, ServerEthernetPort, ServerPortImplementsLANEndpoint, LANEndpoint). The third retrieval pointer has “ServerComputerSystem” to be associated. However, based on the path array information, it is determined that the retrieval cannot be returned, and therefore the retrieval pointer will not be further moved. At this time, the retrieval-lifetime variable becomes 13.

The fourth retrieval pointer further searches for a class to be associated and finds classes such as “ServerEthernetPort,” “SwitchPort,” “FirewallEthernetPort,” and “LANEndpoint.” Based on information about the multiplicity of association, it is determined that the retrieval pointer can be advanced to the “SwitchPort,” “FirewallEthernetPort” and “LANEndpoint” classes, on which fifth to seventh retrieval pointers are set, respectively. At this point in time, the retrieval-lifetime variable becomes 12.

Next, similar processing is carried out for the fifth retrieval pointer, whereby eighth and ninth retrieval pointers are set on “SwitchEthernetPort” and “VLANSwitchEndpoint” classes, respectively. Further, the sixth retrieval pointer can be advanced to “FirewallComputerSystem,” and therefore a tenth retrieval pointer is set on this “FirewallComputerSystem.” The seventh retrieval pointer makes a search from “LANEndpoint” to find “LANEndpoint.” Since there is no restriction by means of multiplicity on this association, it is possible to repeat this search. Therefore, the path array becomes (ServerComputerSystem, ServerSystemDevice, ServerEthernetPort, ServerPortImplementsLANEndpoint, LANEndpoint, LANActiveConnection, LANEndpoint). Here, the seventh retrieval pointer has read that the association between “LANEndpoint” and “LANEndpoint” is unlimited. Therefore, reflecting this fact, the path array may be (ServerComputerSystem, ServerSystemDevice, ServerEthernetPort, ServerPortImplementsLANEndpoint, [LANEndpoint, LANActiveConnection], LANEndpoint) so that the elements in the square brackets [ ] can be repeated. At this time, the retrieval-lifetime variable becomes 11.

Similar operation is continued until the retrieval-lifetime variable becomes zero. Some retrieval pointers reach the “Firewall” class. For example, the sixth retrieval pointer can advance a search to find the “Firewall” class as the association destination. Since the retrieval pointer set here (tenth retrieval pointer) cannot advance a search to its own class, the retrieval pointer remains at this class until the retrieval-lifetime variable becomes zero. However, the path array of this pointer becomes (ServerComputerSystem, ServerSystemDevice, ServerEthernetPort, ServerPortImplementsLANEndpoint, LANEndpoint, FWPortImplementsLANEndpoint, FirewallEthernetPort, FWSystemDevice, FirewallComputerSystem), which does not include the necessary transit-point class, the “SwitchPort” class. Accordingly, this path array will not be a result of the system schema retrieval.

Examples of an information acquisition procedure generated are (ServerComputerSystem, ServerSystemDevice, ServerEthernetPort, ServerPortImplementsLANEndpoint, LANEndpoint, LANActiveConnection, LANEndpoint, SWLANEndpointIdentity, SwitchPort, SWPortImplementsSWEndpoint, SwitchEthernetPort, SWSystemDevice, SwitchComputerSystem, SWSystemDevice, SwitchEthernetPort, SWPortImplementsVLANSWEndpoint, VLANSwitchEndpoint, SwitchEndpointInData, NetworkVLAN, SwitchEndpointInVLAN, VLANSwitchEndpoint, SWPortImplementsVLANSWEndpoint, SwitchEthernetPort, SWPortImplementsSWEndpoint, SwitchPort, SWLANEndpointIdentity, LANEndpoint, LANActiveConnection, LANEndpoint, FWPortImplementsLANEndpoint, FirewallEthernetPort, FWSystemDevice, FirewallComputerSystem), and the like. Hereinafter, this information acquisition procedure will be referred to as information acquisition procedure P.

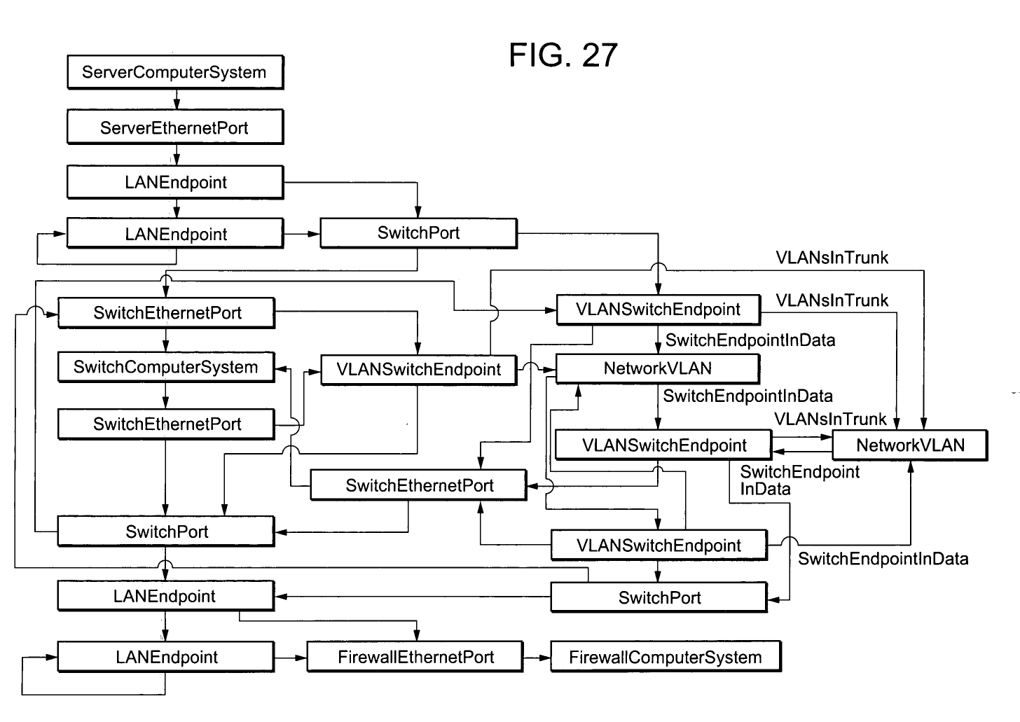

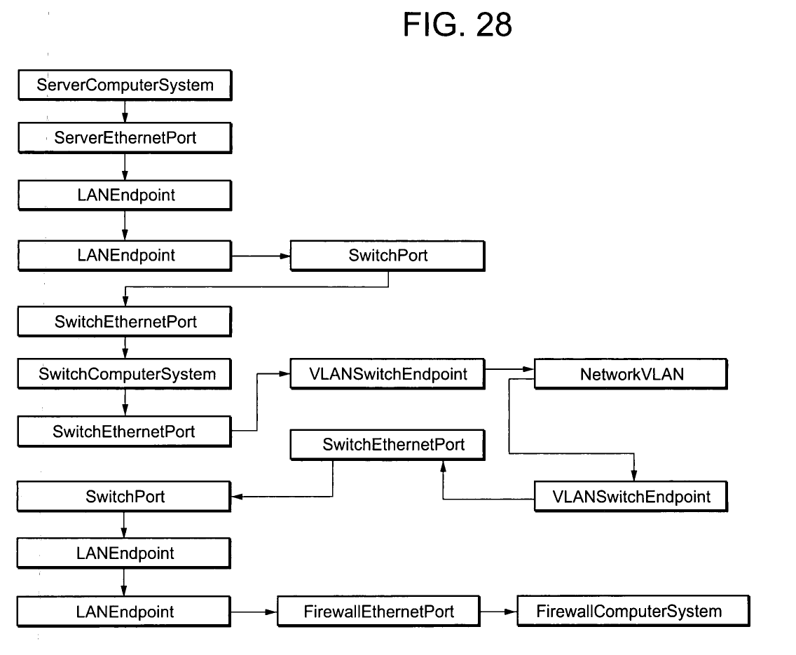

FIG. 27 collectively illustrates a plurality of information acquisition procedures as described above. If the above-described information acquisition procedure P is extracted from the plurality of information acquisition procedures represented in FIG. 27, then the information acquisition procedure P is represented as shown in FIG. 28.

Incidentally, assuming that “WeakAssociation” in CIM means a weak association, an information acquisition procedure defined by classes connected by this weak association may be omitted.

Hereinafter, the “weak association” will be described. It is assumed that a managed system includes two instances corresponding to two classes described in a system schema. Moreover, it is assumed that the identifier of one (assumed to be an instance B) of the two instances includes the identifier of the other (assumed to be an instance A). This state is described as “the identifier of the instance A propagates to the instance B.” When the identifier propagates from one instance to the other as described above, the classes in a system schema are said to be connected by a “weak association.” Additionally, in the system schemas shown in FIG. 8 and the others, when two classes are connected by a weak association, this state is represented by adding “w” to the association between the classes. This symbol “w” is additionally described at a side of a class to whose corresponding instance the identifier propagates.

A specific example of the propagation of an identifier will be described. It is assumed that, in a system schema, a class A represents a server and a class B represents an OS. Moreover, it is assumed that, in an actual managed system, the identifier of the server is described as “ComputerSystem.name=host1” and the identifier of the OS is described as “OperatingSystem.name=windows;ComputerSystem.name=host1.” In this case, the identifier of the server is included in the identifier of the OS, which means that the identifier of the server propagates to the identifier of the OS. If the information acquisition procedure executer 224 acquires the identifier of an element to which the identifier of another element propagates when acquiring information from a managed system, the information acquisition procedure executer 224 does not need to acquire the identifier of the other element separately. Therefore, of two classes connected by a weak association, a class corresponding to an instance to which the identifier of the other element propagates can be excluded from retrieval targets in a system schema. Note that since a system schema is represented using classes, the system schema does not have information about the identifier itself of each element. However, the system schema stores information such that an identifier propagates. This information is indicated by the symbol “w” in FIG. 8 and the others.

A description will be given of an example when a class is removed from retrieval targets. For example, the following information is stored. In a relationship of sequence: (SwitchEthernetPort, SWSystemDevice, SwitchComputerSystem) that is present in the above-mentioned path array, “SwitchEthernetPort” is linked with “SwitchComputerSystem” by a weak association, and the identifier propagates. Therefore, “SwitchComputerSystem” may be excluded from candidates of targets of the retrieval from “SwitchEthernetPort.” A plurality of information acquisition procedures obtained by excluding “SwitchComputerSystem” from candidates of targets of the retrieval are stored in the information acquisition procedure storage section. When acquiring an identifier in accordance with the information acquisition procedure, information acquisition processing of separately acquiring information of “SwitchComputerSystem” after acquiring the identifier information of “SwitchEthernetPort” will be omitted.

A stored information acquisition procedure is outputted by the information association request interpreter 221 (see FIG. 7) from the information acquisition procedure storage section 232 (see FIG. 7) and then executed. It is assumed that the information acquisition procedure P, composed of the aforementioned example of the path array, is executed. The first information acquisition process of this procedure is (ServerComputerSystem, ServerSystemDevice, ServerEthernetPort). Here, an acquire instruction corresponding to this process may be an ipconfig instruction, which is executed on a console of a server. Alternatively, an Associator instruction may be executed, with arguments of “Server,” “SystemDevice” and “EthernetPort,” on the WBEM server 2250, which acquires resource information for the management server 2260. It is assumed that “server 2233” is the identifier of the server inputted from the input device and that “EthernetPort” with an identifier “eth0” is acquired when the information acquisition process is executed using some method.

Subsequently, an information acquisition process corresponding to the path array (ServerEthernetPort, ServerPortImplementsLANEndpoint, LANEndpoint) is executed. Information on “LANEndpoint” is acquired based on the identifier “eth0 in the server 2233.” Thus, “LANEndpoint” with a MAC address “11:11:11:11:11:11” is assumed to be found.

Next, based on “LANEndpoint” with the above MAC address, an information acquisition process corresponding to (LANEndpoint, LANActiveConnection, LANEndpoint) is executed. It is assumed that such information that a connection is established to the port 2223 of a switch is obtained by that execution. Thereafter, based on the information obtained, in a similar manner, information such as “port number 3 of the port 2223” can be acquired as the information of “SwitchPort,” and information “switch 2220” can be acquired as the information of “SwitchComputerSystem.” From the information of “SwitchEthernetPort” that can be acquired from “SwitchComputerSystem” multiple pieces of information “port 2221,” “port 2222,” “port 2224,” “port 2225,” and “port 2226” can be acquired. Here, it is assumed that the information on the port 2223 is not detected in this process because this information has been detected already.

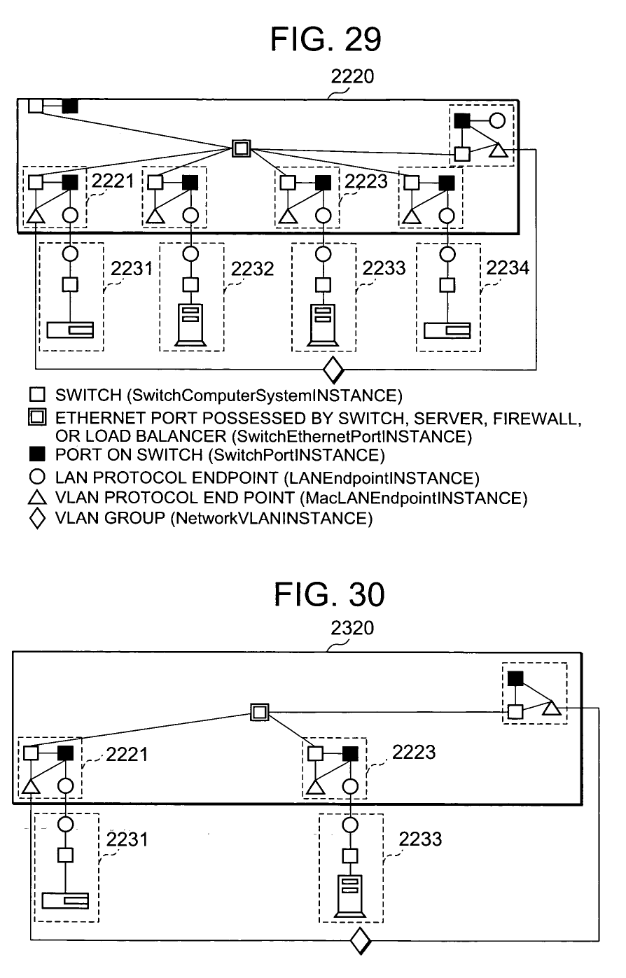

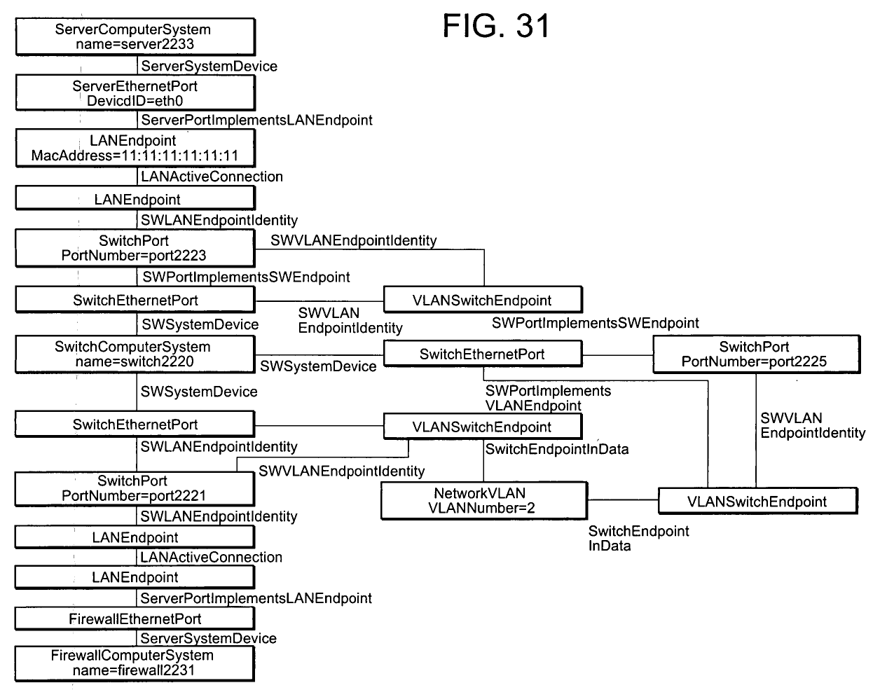

FIG. 29 shows the system information concerning the switch 2220 shown in FIG. 26 in accordance with a system schema. From the information shown in FIG. 29, detected is such information that the server 2233 is connected to the firewall 2231, thereby forming a closed circuit as shown in FIG. 30.

FIG. 31 is a representation obtained by superimposing a plurality of detection results shown in FIG. 30 as instances based on the system schema. If one result is taken out of the results shown in FIG. 30, the array of this result is a series of instances, for example, (ServerComputerSystem.name=Server 2233, ServerEthernetPort.name=eth0, LANEndpoint.MACAddress=11:11:11:11:11:11, . . . , SwitchPort.PortNumber=port 2223, . . . , SwitchComputerSystem.name=switch 2220, . . . , SwitchPort.PortNumber=port 2225, . . . , NetworkVLAN=VLAN number2, . . . , SwitchPortNumber=port 2221, . . . , FirewallComputerSystem.name=firewall 2231).

The meaning contained in this result is that the server 2233 is connected to the port 2223, the port 2225 belonging to the same switch as the port 2223 is connected to the port 2221 by the VLAN number2, and the port 2221 is connected to the target firewall. This information acquisition result is sent to the output device from the information acquisition procedure executer via the information association request interpreter. The output device may analyze this result and determine that, to connect the server 2333 to the firewall 2231, the VLAN number2 should be set to the port 2223 of the switch 2220. Alternatively, a system administrator may analyze the results shown in FIG. 31 and determine that, to connect the server 2333 to the firewall 2231, the VLAN number2 should be set to the port 2223 of the switch 2220.

In this example, since the input device does not designate a class and an association class of information in an association result, all the series of the acquisition results are returned. However, when the input device designates a specific class, only those belonging to the class may be selected from the above-mentioned results. In the case of the above example, if a system administrator is interested only in the identifier of a switch connecting the server and the firewall, “SwitchComputerSystem” may be designated.

Note that an information association result is dependent on a system schema. Therefore, it is desirable that the output device grasps classes and the meanings of associations in a system schema. For example, in the case of the above example, when a result includes an association element “ServerSystemDevice,” the output device preferably knows that the association element “ServerSystemDevice” means that the server has the device.

Moreover, in the above example, if the ports 2221 and 2225 do not belong to the same VLAN, the association result will not be included. In this case, the input device may input a second information association request, depending on a result obtained upon a first information association request. In the above example, a relationship between the server 2233 and the firewall 2231 is detected upon the first information association request. Then, as the second information association request, the input device may input an association request to acquire the VLAN based on the port number of the switch acquired as a result upon the first information association request. In addition, the input device may input the second information association request to the information association request interpreter 221, depending on a system administrator's decision and operation.

### EXAMPLE 2

Next, an example will be given when a system schema includes elements having inheritance relationships.

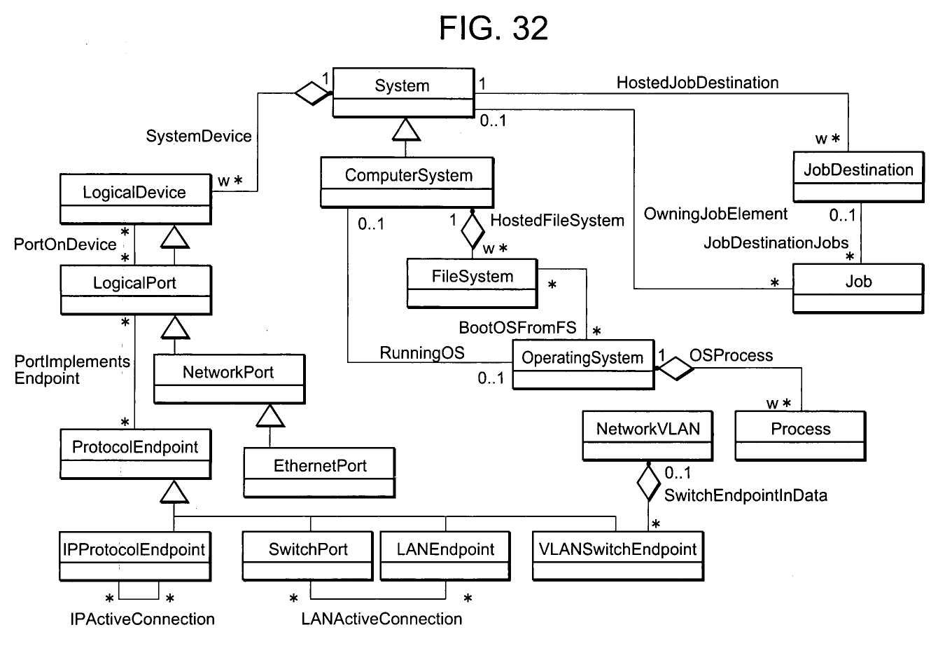

FIG. 32 shows an example of a system schema that includes elements having inheritance relationships. It is assumed that the system schema storage section 231 stores the system schema shown in FIG. 32. In FIG. 32, such a relationship that a class (assumed to be a class B) inherits from another class (assumed to be a class A) is indicated by an arrow extending from the class B to the class A. Moreover, in the system schema shown in FIG. 32, it is assumed that a “FileSystem” class is the starting point, that an “EthernetPort” class is the end point, and that the system schema retriever 222 starts a search from the “FileSystem” class.

Starting from the “FileSystem” class, the system schema retriever 222 follows an association “HostedFileSystem” and retrieves a “ComputerSystem” class. In addition, the system schema retriever 222 follows an association “BootOSFromFS” and retrieves an “OperatingSystem” class.

The system schema retriever 222 looks at the retrieved “ComputerSystem” class and determines a next search target. Since the “FileSystem” class and the “OperatingSystem” class exist as a class that is directly associated with the “ComputerSystem” class, the system schema retriever 222 first takes the “FileSystem” and “OperatingSystem” classes as candidates of search target. Moreover, the system schema retriever 222 checks whether or not an element exists that is associated with the retrieved “ComputerSystem” class through the inheritance relationship, even though not associated directly.

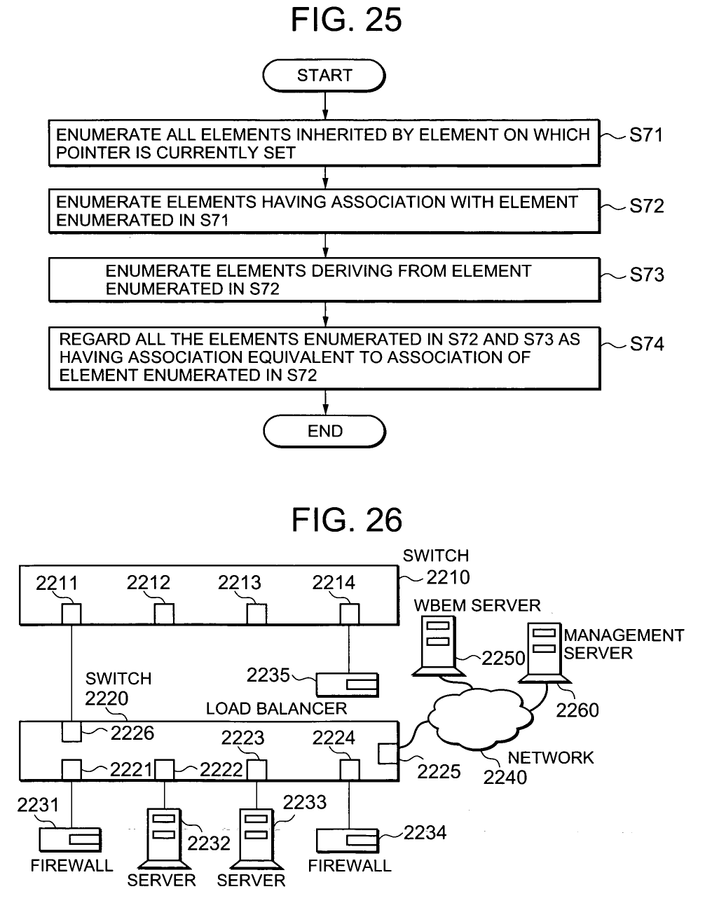

First, the system schema retriever 222 enumerates a “System” class as an element from which the “ComputerSystem” class inherits (Step S71, see FIG. 25). Subsequently, as an element directly associated with the “System” class, the system schema retriever 222 enumerates a “JobDestination” class associated through a “HostedJobDestination” association, a “Job” class associated through an “OwningJobElement” association, and a “LogicalDevice” class associated through a “SystemDevice” association (Step S72, see FIG. 25). Next, for each of the three classes enumerated here, the system schema retriever 222 checks whether or not a class that inherits from the class in question exists. Here, as a class inheriting from the “LogicalDevice” class, the system schema retriever 222 enumerates a “LogicalPort” class, a “NetworkPort” class and an “EthernetPort” class (Step S73, see FIG. 25). The system schema retriever 222 then sets all the classes enumerated at Steps S72 and S73 as candidates of target of the search from the “ComputerSystem” class (Step S74, see FIG. 25).

That is, the classes associated with the “ComputerSystem” class through the inheritance relationship are the six classes, namely, the “JobDestination” class associated through the “HostedJobDestination” association, the “Job” class associated through the “OwningJobElement” association, the “LogicalDevice” class associated through the “SystemDevice” association, the “LogicalPort” class associated through the “SystemDevice” association, the “NetworkPort” class associated through the “SystemDevice” association, and the “EthernetPort” class associated through the “SystemDevice” association. Accordingly, the system schema retriever 222 sets these six classes associated through the inheritance relationship and the two classes (“FileSystem” class and “OperatingSystem” class) directly associated as candidates of the next search target.

The present invention can be applied to an information retrieval device for automatically specifying equipment to be controlled in a computer network and information for controlling the equipment. In addition, the present invention can also be applied to a program for causing a computer to function as such an information retrieval device.

1. An apparatus for managing a network system including a plurality of system elements, comprising:
a system schema memory for storing a system schema which describes a configuration of a managed network system by modeling the system elements and associations between the system elements in predetermined representation form; and
an information acquisition procedure generator for generating an information acquisition procedure based on input information of two system elements and the system schema, wherein the information acquisition procedure is used to acquire information of system element and association linking the two system elements from the managed network system.

2. The apparatus according to claim 1, wherein the information acquisition procedure generator comprises:
a searcher for searching the system schema memory for modeled information of system element and association linking the two system elements by sequentially finding modeled information of a system element associated with a single system element and modeled information of an association between the single system element and the associated system element from one of the two system elements to the other of two system elements.

3. The apparatus according to claim 2, wherein
the system schema stored in the system schema memory includes a multiplicity which indicates a number of entities of a system element associated with a single system element when said single system element is associated with one of the single system element itself and another system element,
wherein the searcher is prohibited from performing such a returning operation as to search for the single system element from the associated system element and thereafter again search for the associated system element a number of times equal to or greater than the number of entities indicated by the multiplicity.

4. The apparatus according to claim 1, further comprising:
an element designating section for designating a system element to be included in the information acquisition procedure or a system element to be excluded from the information acquisition procedure,
wherein, when a system element is designated as one to be included, the information acquisition procedure generator generates the information acquisition procedure including modeled information of the system element that is designated as one to be included, and when a system element is designated as one to be excluded, the information acquisition procedure generator generates the information acquisition procedure excluding modeled information of the system element that is designated as one to be excluded.

5. The apparatus according to claim 1, further comprising:
an association designating section for designating an association to be included in the information acquisition procedure or an association to be excluded from the information acquisition procedure,
wherein, when an association is designated as one to be included, the information acquisition procedure generator generates the information acquisition procedure including modeled information of the association that is designated as one to be included, and when an association is designated as one to be excluded, the information acquisition procedure generator generates the information acquisition procedure excluding modeled information of the association that is designated as one to be excluded.

6. The apparatus according to claim 4, further comprising:
an association designating section for designating an association to be included in the information acquisition procedure or an association to be excluded from the information acquisition procedure,
wherein, when an association is designated as one to be included, the information acquisition procedure generator generates the information acquisition procedure including modeled information of the association that is designated as one to be included, and when an association is designated as one to be excluded, the information acquisition procedure generator generates the information acquisition procedure excluding modeled information of the association that is designated as one to be excluded.

7. The apparatus according to claim 1, further comprising:
an information acquisition section for acquiring information of system element and association linking the two system elements from the managed network system according to the information acquisition procedure generated by the information acquisition procedure generator.

8. The apparatus according to claim 7, further comprising:
an output section for outputting information acquired by the information acquisition section; and
a condition designating section for designating a condition under which the information to be outputted is determined,
wherein the information acquisition section acquires information satisfying the condition designated from the managed network system.

9. The apparatus according to claim 7, further comprising:
an output section for outputting information acquired by the information acquisition section; and
a condition designating section for designating a condition under which the information to be outputted is determined,
wherein the output section outputs information satisfying the condition designated of information acquired by the managed network system.

10. The apparatus according to claim 1, wherein the system schema memory stores a plurality of system schemas, the apparatus further comprising:
a system schema selector for selecting one of the plurality of system schemas depending on a system schema selection instruction received from outside,
wherein the information acquisition procedure generator generates an information acquisition procedure based on a system schema selected by the system schema selector.

11. The apparatus according to claim 1, wherein the system schema memory stores a plurality of system schemas, the apparatus further comprising:
a system schema selector for selecting one of the plurality of system schemas depending on the input information of the two system elements,
wherein the information acquisition procedure generator generates an information acquisition procedure based on a system schema selected by the system schema selector.

12. The apparatus according to claim 1, wherein the system schema stored in the system schema memory includes modeled information of system elements having an inheritance relationship,
wherein, when searching for modeled information of a system element associated with a system element inheriting from another system element, the searcher also searches for modeled information of a system element associated with the other system element and a system element inheriting from a system element associated with the other system element.

13. The apparatus according to claim 2, wherein the system schema stored in the system schema memory includes modeled information of system elements having an inheritance relationship,
wherein, when searching for modeled information of a system element associated with a system element inheriting from another system element, the searcher also searches for modeled information of a system element associated with the other system element and a system element inheriting from a system element associated with the other system element.

14. The apparatus according to claim 3, wherein the system schema stored in the system schema memory includes modeled information of system elements having an inheritance relationship,
wherein, when searching for modeled information of a system element associated with a system element inheriting from another system element, the searcher also searches for modeled information of a system element associated with the other system element and a system element inheriting from a system element associated with the other system element.

15. A method for managing a network system including a plurality of system elements, comprising:
storing a system schema in a system schema memory, wherein the system schema describes a configuration of a managed network system by modeling the system elements and associations between the system elements in predetermined representation form;
inputting information of two system elements of the plurality of system elements; and
generating an information acquisition procedure based on input information of the two system elements and the system schema, wherein the information acquisition procedure is used to acquire information of system element and association linking the two system elements from the managed network system.

16. The method according to claim 15, wherein the information acquisition procedure is generated by:
searching the system schema memory for modeled information of system element and association linking the two system elements by sequentially finding modeled information of a system element associated with a single system element and modeled information of an association between the single system element and the associated system element from one of the two system elements to the other of two system elements.

17. The method according to claim 16, wherein the system schema includes a multiplicity which indicates a number of entities of a system element associated with a single system element when said single system element is associated with one of the single system element itself and another system element,
wherein search of the system schema memory is prohibited from performing such a returning operation as to search for the single system element from the associated system element and thereafter again search for the associated system element a number of times equal to or greater than the number of entities indicated by the multiplicity.

18. A system for managing a network system including a plurality of system elements, comprising:
a system schema memory for storing a system schema which describes a configuration of a managed network system by modeling the system elements and associations between the system elements in predetermined representation form; and
means for generating an information acquisition procedure based on input information of two system elements and the system schema, wherein the information acquisition procedure is used to acquire information of system element and association linking the two system elements from the managed network system.

19. A computer-readable program instructing a computer to manage a network system including a plurality of system elements, wherein the computer comprises a system schema memory storing a system schema which describes a configuration of a managed network system by modeling the system elements and associations between the system elements in predetermined representation form, the program comprising the step of:
generating an information acquisition procedure based on input information of two system elements and the system schema, wherein the information acquisition procedure is used to acquire information of system element and association linking the two system elements from the managed network system.

20. A recording medium storing a program for instructing a computer to manage a network system including a plurality of system elements, wherein the computer comprises a system schema memory storing a system schema which describes a configuration of a managed network system by modeling the system elements and associations between the system elements in predetermined representation form, the program comprising the step of:
generating an information acquisition procedure based on input information of two system elements and the system schema, wherein the information acquisition procedure is used to acquire information of system element and association linking the two system elements from the managed network system.
